(19) United States
(12) Patent Application Publication
(10) Pub. No.: US 2015/0215327 A1
(43) Pub. Date: Jul. 30, 2015

(54) METHOD AND SYSTEM FOR EXTRUSION AND INTRUSION DETECTION IN A CLOUD COMPUTING ENVIRONMENT USING NETWORK COMMUNICATIONS DEVICES

(71) Applicant: Intuit Inc., Mountain View, CA (US)

(72) Inventors: Luis Felipe Cabrera, Bellevue, WA (US); Eric Jason Hlutke, San Diego, CA (US); Bond Masuda, Chula Vista, CA (US); Jacob Brunetto, El Cajon, CA (US); Jeff Seifers, Sparks, NV (US); M. Shannon Lietz, San Marcos, CA (US)

(73) Assignee: INTUIT INC., Mountain View, CA (US)

(21) Appl. No.: 14/166,116

(22) Filed: Jan. 28, 2014

(51) Int. Cl. H04L 29/06

(52) U.S. Cl. CPC H04L 63/1408

(57) ABSTRACT

An analysis trigger monitoring system is provided in a network communications device associated with a cloud computing environment. One or more analysis trigger parameters are defined and analysis trigger data representing the analysis trigger parameters is generated. The analysis trigger data is then provided to the analysis trigger monitoring system and the analysis trigger monitoring system is used to monitor at least a portion of the message traffic sent to, or sent from, virtual assets in the cloud computing environment and relayed by the network communications device through a network communication channel to detect any message including one or more of the one or more analysis trigger parameters. A copy of at least a portion of any detected message including one or more of the one or more analysis trigger parameters is then transferred to one or more analysis systems for further analysis using a second communication channel that is separate from the network communication channel.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based infrastructures, and/or other distributive computing models. This is because many owners and operators of data centers that provide access to data and other resources are extremely hesitant to allow their data and resources to be accessed, processed, and/or otherwise used, by virtual assets, such as virtual machine and server instances, in the cloud.

In a cloud computing environment, various virtual assets, such as, but not limited to, virtual machine instances, data stores, and various services, are created, launched, or instantiated, in the cloud for use by an “owner” of the virtual asset, herein also referred to as a user of the virtual asset.

Herein the terms “owner” and “user” of a virtual asset include, but are not limited to, applications, systems, and sub-systems of software and/or hardware, as well as persons or entities associated with an account number, or other identity, through which the virtual asset is purchased, approved, managed, used, and/or created.

Typically a given cloud computing environment receives message traffic through one or more network communications channels. One long standing problem associated with cloud computing environments is the fact that malware can be introduced into the cloud computing environment, just as in any computing environment, via these network communications channels. The introduction of malware into a virtual asset, and therefore into an application, service, enterprise, or cloud infrastructure of a cloud computing environment is known as intrusion. However, once introduced, some forms of malware take control of some, or all, of the infected virtual asset functionality and use the virtual asset to send outbound messages and data. This outbound malware mechanism is referred to as extrusion.

The detection of both malware intrusion and extrusion is an important part of making cloud computing environments more secure. However, a given cloud computing environment can include hundreds, thousands, or even millions, of virtual machines and other assets, owned or used by hundreds, thousands, or even millions, of parties and, in many cases, a given application or service can operate within, and interface with, multiple cloud computing environments. Consequently, detecting malware intrusion and extrusion is an extremely difficult and resource intensive task.

What is needed is a method and system for detecting malware intrusion and extrusion in cloud computing environments that makes use of existing could infrastructure and communications devices and functionality.

### SUMMARY

In accordance with one embodiment, a method and system for extrusion detection in a cloud computing environment using network communications devices includes providing one or more cloud computing environments. In one embodiment, each cloud computing environment includes one or more virtual assets. In one embodiment, each of the one or more cloud computing environments is provided at least one network communications device that receives, and/or relays, message traffic sent over a network communication channel from any of the one or more virtual assets included in the cloud computing environment.

In one embodiment, an analysis trigger monitoring system is provided for the network communications device. In one embodiment, one or more analysis trigger parameters are defined and analysis trigger data representing the analysis trigger parameters is generated. In one embodiment, the analysis trigger data is provided to the analysis trigger monitoring system for at least one communication device associated with each cloud computing environment. The analysis trigger monitoring system and the analysis trigger data are then used to monitor at least a portion of the message traffic sent through the network communications channel and the network communications device from each of the one or more virtual assets in the cloud computing environment assigned to the analysis trigger monitoring system to detect any message including one or more of the one or more analysis trigger parameters.

In one embodiment, any detected message including one or more of the one or more analysis trigger parameters is identified as a suspect message and, for each suspect message, suspect message copy data representing a copy of at least a portion of the suspect message is generated. In one embodiment, the suspect message copy data is then transferred to one or more analysis systems for further analysis.

In accordance with one embodiment, a method and system for intrusion detection in a cloud computing environment using network communications devices includes providing one or more cloud computing environments. In one embodiment, each cloud computing environment includes one or more virtual assets. In one embodiment, each of the one or more cloud computing environments is provided at least one network communications device that receives, and/or relays, message traffic sent over a network communication channel to any of the one or more virtual assets included in the cloud computing environment.

In one embodiment, an analysis trigger monitoring system is provided for the network communications device. In one embodiment, one or more analysis trigger parameters are defined and analysis trigger data representing the analysis trigger parameters is generated. In one embodiment, the analysis trigger data is provided to the analysis trigger monitoring system for at least one communication device associated with each cloud computing environment. The analysis trigger monitoring system and the analysis trigger data are then used to monitor at least a portion of the message traffic sent through the network communications channel and the network communications device to each of the one or more virtual assets in the cloud computing environment assigned to the analysis trigger monitoring system to detect any message including one or more of the one or more analysis trigger parameters.

In one embodiment, any detected message including one or more of the one or more analysis trigger parameters is identified as a suspect message and, for each suspect message, suspect message copy data representing a copy of at least a portion of the suspect message is generated. In one embodiment, the suspect message copy data is then transferred to one or more analysis systems for further analysis.

### BRIEF DESCRIPTION OF THE DRAWINGS

FIG. 1 is a functional block diagram showing the interaction of various elements for implementing one embodiment;

FIG. 2 is a more detailed functional diagram of a network communications device and analysis and trigger monitor in accordance with one embodiment;

FIG. 3 is a flow chart depicting a process for extrusion detection in a cloud computing environment using network communications devices in accordance with one embodiment;

FIG. 4 is a flow chart depicting a process for intrusion detection in a cloud computing environment using network communications devices in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, methods and systems for extrusion, and/or intrusion, detection in a cloud computing environment using network communications devices include processes for extrusion, and/or intrusion, detection in a cloud computing environment using network communications devices implemented, at least in part, by one or more computing systems.

As used herein, the term “computing system”, includes, but is not limited to, a server computing system; a workstation; a desktop computing system; a database system or storage cluster; a switching system; a router; any hardware system; any communications systems; any form of proxy system; a gateway system; a firewall system; a load balancing system; or any device, subsystem, or mechanism that includes components that can execute all, or part, of any one of the processes and/or operations as described herein.

In addition, as used herein, the term computing system, can denote, but is not limited to, systems made up of multiple server computing systems; workstations; desktop computing systems; database systems or storage clusters; switching systems; routers; hardware systems; communications systems; proxy systems; gateway systems; firewall systems; load balancing systems; or any devices that can be used to perform the processes and/or operations as described herein.

In various embodiments, the one or more computing systems implementing the processes for extrusion, and/or intrusion, detection in a cloud computing environment using network communications devices are logically or physically located, and/or associated with, two or more computing environments. As used herein, the term “computing environment” includes, but is not limited to, a logical or physical grouping of connected or networked computing systems using the same infrastructure and systems such as, but not limited to, hardware systems, software systems, and networking/communications systems. Typically, computing environments are either known environments, e.g., “trusted” environments, or unknown, e.g., “untrusted” environments. Typically trusted computing environments are those where the components, infrastructure, communication and networking systems, and security systems associated with the computing systems making up the trusted computing environment, are either under the control of, or known to, a party. In contrast, unknown, or untrusted computing environments are environments and systems where the components, infrastructure, communication and networking systems, and security systems implemented and associated with the computing systems making up the untrusted computing environment, are not under the control of, and/or are not known by, a party, and/or are dynamically configured with new elements capable of being added that are unknown to the party.

Examples of trusted computing environments include the components making up data centers associated with, and/or controlled by, a party and/or any computing systems, and/or networks of computing systems, associated with, known by, and/or controlled by, a party. Examples of untrusted computing environments include, but are not limited to, public networks, such as the Internet, various cloud-based computing environments, and various other forms of distributed computing systems.

It is often the case that a party desires to transfer data to, and/or from, a first computing environment that is an untrusted computing environment, such as, but not limited to, a public cloud, a virtual private cloud, and a trusted computing environment, such as, but not limited to, networks of computing systems in a data center controlled by, and/or associated with, the party. However, in other situations a party may wish to transfer data between two trusted computing environments, and/or two untrusted computing environments.

In one embodiment, two or more computing systems, and/or two or more computing environments, are connected by one or more communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

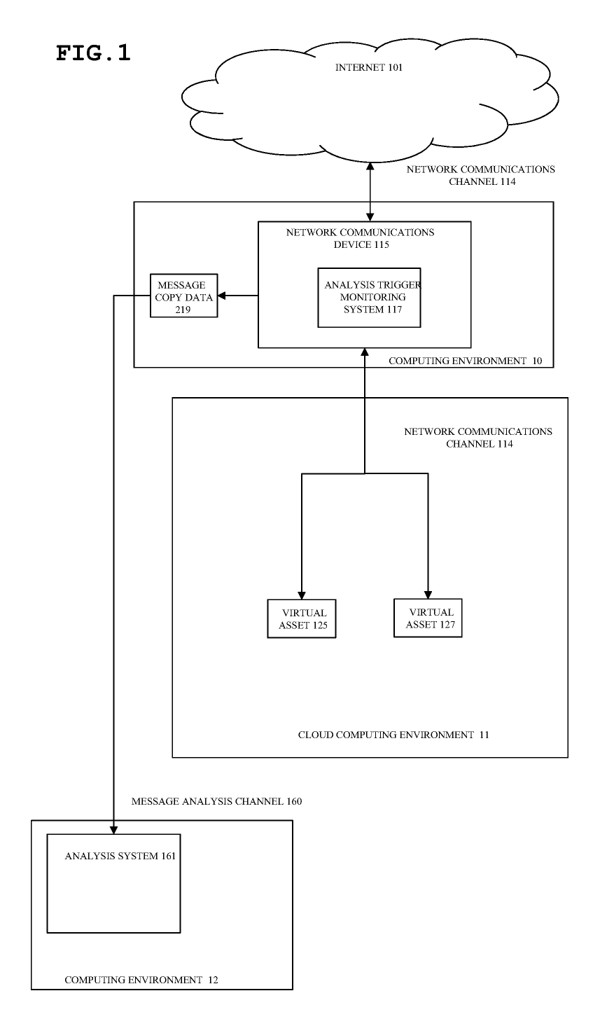

FIG. 1 is a functional diagram of the interaction of various elements associated with one embodiment of the methods and systems for extrusion, and/or intrusion, detection in a cloud computing environment using network communications devices discussed herein. Of particular note, the various elements in FIG. 1 are shown for illustrative purposes as being associated with specific computing environments, such as computing environment 10, computing environment 11, and computing environment 12. However, the exemplary placement of the various elements within these environments and systems in FIG. 1 is made for illustrative purposes only and, in various embodiments, any individual element shown in FIG. 1, or combination of elements shown in FIG. 1, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components as discussed herein, and/or as known in the art at the time of filing, and/or as developed/made available after the time of filing.

In addition, the elements shown in FIG. 1, and/or the computing environments, systems and architectural and/or infrastructure components, deploying the elements shown in FIG. 1, can be under the control of, or otherwise associated with, various parties or entities, or multiple parties or entities, such as, but not limited to, the owner of a data center, a party and/or entity providing all or a portion of a cloud-based computing environment, the owner or a provider of a service, the owner or provider of one or more resources, and/or any other party and/or entity providing one or more functions, and/or any other party and/or entity as discussed herein, and/or as known in the art at the time of filing, and/or as made known after the time of filing.

In one embodiment, a cloud computing environment is provided. In various embodiment, the provided cloud computing environment can be any form of cloud computing environment, such as, but not limited to, a Virtual Private Cloud, or VPC.

In many cases, a given application or service provided through a cloud computing infrastructure may utilize, and interface with, multiple cloud computing environments, including multiple VPCs, in the course of providing the associated service. As noted above, each cloud computing environment includes allocated virtual assets associated with, and controlled or used by, the party utilizing the cloud computing environment.

As used herein, the term “virtual asset” includes any virtualized entity or resource, and/or part of an actual, or “bare metal” entity requiring access to various resources, and types of resources. In various embodiments, the virtual assets can be, but are not limited to, virtual machines, virtual servers, and instances implemented in a cloud computing environment; databases implemented, or associated with, a cloud computing environment, and/or instances implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc. requiring access to various resources, and/or types of resources, located within a data center, within a cloud computing environment, and/or any other physical or logical location, as discussed herein, and/or as known/available in the art at the time of filing, and/or as developed/made available after the time of filing.

In one embodiment, virtual asset creation data is generated through a virtual asset creation system such as a virtual asset template through which the creator of a virtual asset can generate operational logic and assign resources and attributes to the virtual assets to be instantiated in a cloud computing environment, such as a virtual private cloud computing environment.

In one embodiment, a network communications device is included with each cloud computing environment provided. In one embodiment, outgoing message traffic sent from one or more of the virtual assets associated with a given cloud computing environment to a destination external to the cloud computing environment, such as the Internet, and/or incoming message traffic sent to one or more of the virtual assets associated with a given cloud computing environment from an origin external to the cloud computing environment, such as the Internet, is relayed through the network communications device for that cloud computing environment.

In various embodiments, the network communications devices for the cloud computing environment include, but are not limited to, one or more of a switching system, such as a network switch; a router; a border router; any gateway system; a firewall system; a load balancing system; or any communication, relay, or routing system, as discussed herein, and/or as known in the art at the time of filing, and/or as developed after the time of filing, through which message traffic on a network communications channel to, or from, an external network, such as the Internet, is relayed, and/or routed, to one or more virtual assets in a cloud computing environment.

In one embodiment, the outgoing message traffic, and/or incoming message traffic, is relayed through the network communications device via at least one communications channel, e.g., a network communications channel, herein also referred to as a first communications channel.

As noted above, in various embodiments, the outgoing, and/or incoming, message traffic to, and/or from, the virtual assets associated with a given cloud computing environment are susceptible to the introduction of malware and, in particular, extrusion, and/or intrusion, related malware.

As also noted above, the fact that malware can be introduced into the cloud computing environment is a long standing problem. As also noted above, the introduction of malware into a virtual asset via one or more messages included in message traffic relayed by the network communications device, is known as intrusion. However, as also noted above, once introduced, some forms of malware take control of some, or all, of the infected virtual asset functionality and use the virtual asset to send outgoing messages and data through the message traffic relayed by the network communications device. This outbound malware mechanism is referred to as extrusion.

Consequently, the detection of both malware intrusion and extrusion is an important part of making cloud computing environments more secure. However, as also noted above, a given cloud computing environment, and/or VPC, can include hundreds, thousands, or even millions, of virtual assets, owned or used by hundreds, thousands, or even millions, of parties. Consequently, detecting malware intrusion and extrusion in a cloud computing environment is currently an extremely difficult and resource intensive task.

To address this issue, as discussed below, in one embodiment, the network communications device assigned to a cloud computing environment and relaying all incoming, and/or outgoing, message traffic, is provided an analysis trigger monitoring system. In various embodiments, the analysis trigger monitoring system is a module of software, and/or firmware, and/or hardware, implemented in, or on, the network communications device and capable of monitoring at least a portion of the message traffic to, between, and from, the at least one virtual asset instantiated in an assigned cloud computing environment.

In various embodiments, the analysis trigger monitoring system is a module of software implemented within the network communications device assigned to a cloud computing environment.

In various embodiments, the analysis trigger monitoring system is a module of firmware implemented within the network communications device assigned to a cloud computing environment.

In various embodiments, the analysis trigger monitoring system is an Application Specific Integrated Circuit (ASIC) included with, or associated with, the network communications device assigned to a cloud computing environment.

In various embodiments, the methods and systems for intrusion and extrusion detection discussed herein are applied to network communications, e.g., message traffic, which is in plain text or is encrypted. Consequently, in some embodiments, the analysis trigger monitoring system, and/or the network communications device, includes a decryption capability to decrypt outgoing and incoming message traffic as part of the monitoring and analysis. In other embodiments, a decryption capability is provided to decrypt outgoing and incoming message traffic prior to being provided to analysis trigger monitoring system and any monitoring and analysis.

As discussed below, in some embodiments, the analysis trigger monitoring system allows for analysis policies to be added, or removed, dynamically based on alerts that are received.

Referring to FIG. 1, cloud computing environment 11 is shown, along with illustrative computing environments 10 and 12. Herein, cloud computing environment 11 and computing environments 10 and 12 are referred to collectively as computing environments 10, 11, and 12.

Also shown in FIG. 1 is Internet 101 that, in this specific illustrative example, is the origin, and/or destination, external to cloud computing environment 11. As seen in FIG. 1, Internet 101 is communicatively coupled to cloud computing environment 11 via network communications channel 114 and network communications device 115, shown in this illustrative example as implemented computing environment 10.

As seen in FIG. 1 Internet 101 is communicatively coupled to network communications device 115, through which all message traffic to, and from, virtual assets 125 and 127 in cloud computing environment 11 is relayed via network communications channel 114, also referred to herein as the first communications channel.

As seen in FIG. 1, network communications device 115 is shown as implemented in computing environment 10 that is distinct from computing environment 11 of virtual assets 125 and 127. However, as noted above, this illustrative placement of network communications device 115 is not limiting and, in other embodiments, network communications device 115 can be implemented in any of computing environments 10, 11, or 12.

As also seen in FIG. 1, network communications device 115 is provided with analysis trigger monitoring system 117.

In one embodiment, one or more analysis trigger parameters are defined such that if one or more of the one or more analysis trigger parameters are detected in a message to, or from, a virtual asset, then that message is deemed a suspect message that is potentially associated with an intrusion or extrusion attack on the virtual asset, and/or the cloud computing environment.

In various embodiments, the analysis trigger parameters can be dynamically added, removed, and/or modified to reflect various policies, and/or policy changes made in response to malware alerts.

In various embodiments, specific examples of analysis trigger parameters include, but are not limited to, the presence of an IP address in a message indicating a designated suspect origin or destination. In one embodiment, this analysis trigger parameter is used to detect messages coming from, or going to, a designated suspicious entity that is suspected of being associated with malware. In various embodiments, the IP addresses associated with designated suspicious entities, and/or the identity of the entities themselves, is provided by one or more third parties via alerts or other mechanisms.

In various embodiments, specific examples of analysis trigger parameters include, but are not limited to, the presence of an IP address in a message indicating a designated suspect geographical region. In one embodiment, this analysis trigger parameter is used to detect messages coming from, or going to, geographical locations that are known to be associated with malware. In various embodiments, the geographical locations known to be associated with malware are provided by the one or more third parties via alerts or other mechanisms.

In various embodiments, specific examples of analysis trigger parameters include, but are not limited to, the presence of an IP address in a message indicating an origin or destination that is not included on a list of authorized, or expected, origins or destinations of messages to be received by, or transmitted from, the virtual assets. In one embodiment, this analysis trigger parameter is used to detect message traffic that would not be expected to be generated in the normal course of operation of the virtual assets according to their operational mission.

In various embodiments, specific examples of analysis trigger parameters include, but are not limited to, the presence of an IP address in a message indicating a geographical location that is not included on a list of authorized, or expected, geographical locations to be associated with messages to be received by, or transmitted from, and the virtual assets. In one embodiment, this analysis trigger parameter is used to detect message traffic that would not be expected to be generated in the normal course of operation of the virtual assets according to their operational instructions.

In various embodiments, specific examples of analysis trigger parameters include, but are not limited to, setting a threshold maximum message size and determining that a given message is of a size exceeding the threshold maximum message size. In one embodiment, this analysis trigger parameter takes advantage of the fact that many forms of malware require message sizes larger than those normally associated with a given virtual asset in order to deliver the malware necessary to execute the malicious intent.

In various embodiments, specific examples of analysis trigger parameters include, but are not limited to, setting a threshold minimum message size and determining that a given message is of a size that is less than the threshold minimum message size. In one embodiment, this analysis trigger is used to detect messages of a size that is smaller than a message size determined to be typical with respect to a given virtual asset, and that are therefore suspicious.

In various embodiments, specific examples of analysis trigger parameters include, but are not limited to, analysis trigger parameters based on frequency analysis of the access pattern indicating that messages arrive too frequently or too infrequently.

In various embodiments, specific examples of analysis trigger parameters include, but are not limited to, a hash value of at least part of the message data that is not included in a list of allowed hash values. In one embodiment, this analysis trigger parameter is used in conjunction with a hash-based analysis of at least part of a given message being sent to, and/or transmitted from, a virtual asset. In one embodiment, allowable hash values are defined and then a hash is performed on at least part of a given message. In one embodiment, if the hash of the portion of the given message does not match any of the allowed hash values, the message is determined to be suspect.

In various embodiments, specific examples of analysis trigger parameters include, but are not limited to, an MD5 value of the message data that is not included in a list of allowed MD5 values.

MD5 (Message-Digest algorithm five) is a widely used cryptographic hash function producing a 128 bit (16 byte) hash value that is typically expressed as a 32 digit hexadecimal number. In one embodiment, the MD5 algorithm is applied to at least part of the message data associated with a given message and the resulting MD5 value is compared with a list of allowed MD5 values. If the resulting MD5 value does not match any of the allowed MD5 values, then the message is considered suspect.

In various embodiments, specific examples of analysis trigger parameters include, but are not limited to, the specific identity of the sender of the message and adding the ability to have a per-message offline analysis that determines whether to trigger a message as suspect. In one embodiment, the analysis can be in-line or asynchronously off-line and would typically miss an initial or first example of an intrusion or extrusion message but would be used for other “like messages” where the criteria for “like” is an analysis trigger parameter that can be dynamically installed in the trigger monitoring system. Consequently, in one embodiment, new analysis trigger parameters are discovered and applied heuristically to create a self-learning extrusion and/or intrusion detection system.

In various embodiments, specific examples of analysis trigger parameters include, but are not limited to, the specific identity of the recipient of the message and adding the ability to have a per-message offline analysis that determines whether to trigger a message as suspect. In one embodiment, the analysis can be in-line or asynchronously off-line and would typically miss an initial or first example of an intrusion or extrusion message but would be used for other “like messages” where the criteria for “like” is an analysis trigger parameter that can be dynamically installed in the trigger monitoring system. Consequently, in one embodiment, new analysis trigger parameters are discovered and applied heuristically to create a self-learning extrusion and/or intrusion detection system.

In various other embodiments, any other analysis trigger parameter, or combination of analysis trigger parameters, as discussed herein, and/or as known in the art at the time of filing, and/or as developed after the time of filing is/are defined.

In one embodiment, once the analysis trigger parameters are defined, machine-readable analysis trigger data is generated representing the analysis trigger parameters.

In one embodiment, the analysis trigger data is provided to the analysis trigger monitoring system associated with the network communications device for a given cloud computing environment.

In one embodiment, the analysis trigger data and the analysis trigger monitoring system are then used to monitor at least part of the message data associated with at least some of the message traffic to, and/or from, virtual assets relayed by the network communications device. In one embodiment, at least part of the message data associated with at least some of the message traffic to, and/or from, the virtual assets is monitored to detect one or more of the one or more analysis trigger parameters within the message data.

In one embodiment, the part of the message data associated with at least some of the message traffic from the virtual assets is decrypted by the decryption capability associated with the analysis trigger monitoring system, and/or the network communications device, before the analysis trigger data and the analysis trigger monitoring system are used to monitor at least part of the message data associated with at least some of the message traffic from the virtual assets relayed through the network communications device.

In one embodiment, if one or more of the one or more analysis trigger parameters is detected within the message data associated with a given message, the classification data associated with that message is transformed into classification data indicating that the detected message including one or more of the one or more analysis trigger parameters is a suspect message.

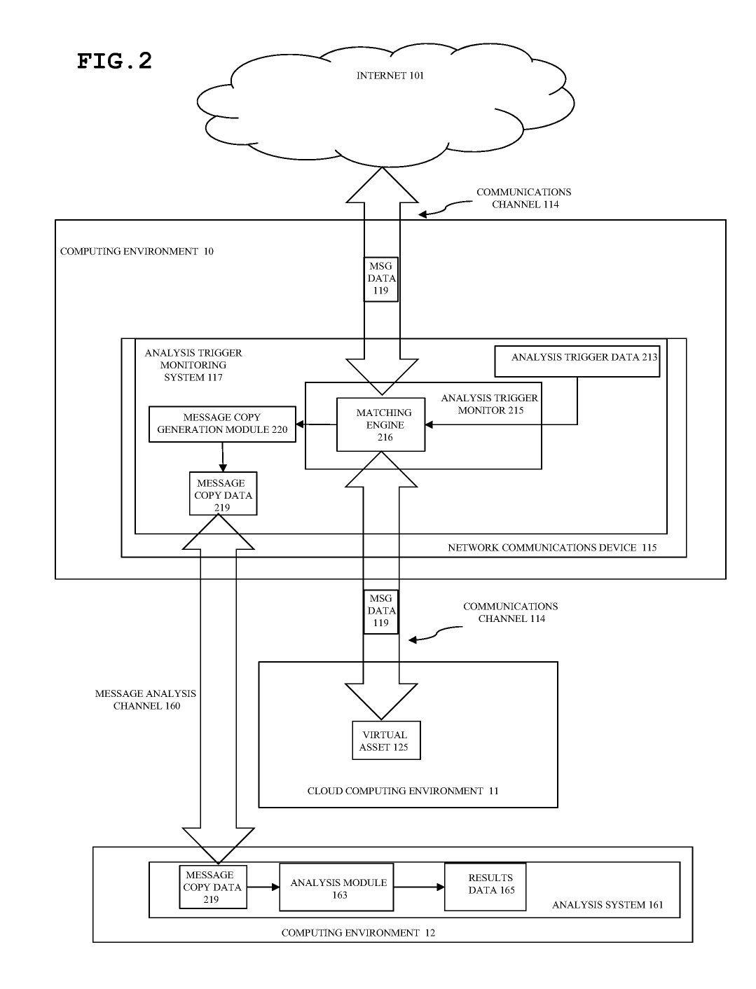

Returning to FIG. 1, analysis trigger monitoring system 117 is shown implemented in network communications device 115. Referring now to FIG. 2, cloud computing environment 10 is shown in more detail.

As seen in FIG. 2, Internet 101 is communicatively coupled to cloud computing environment 10, network communications device 115, and analysis trigger monitoring system 117. As seen in FIG. 2, analysis trigger monitoring system 117 includes analysis trigger monitor 215 and matching engine 216 commutatively coupled to network communications channel 114. As seen in FIG. 2, network communications channel 114 relays message data 119 to, and/or from, virtual asset 125.

As also seen in FIG. 2, analysis trigger data 213, representing defined analysis trigger parameters, is shown as second input data to matching engine 216 of analysis trigger monitor 215.

In one embodiment, the detected suspect messages are temporarily permitted to be transmitted to, and/or from, the virtual assets through the network communications channel, i.e. the first communications channel, with minimal delay. In one embodiment, these transmissions are permitted in order to avoid significantly disrupting or delaying the transmission of messages without further evidence that the suspect messages are indeed malicious. However, for each detected suspect message, suspect message copy data is generated representing a copy of at least part of the message data making up the suspect message.

Consequently, in one embodiment, the analysis performed by the analysis trigger monitoring system can be performed in-line or asynchronously off-line on a per-message basis that would then miss an initial or first example of an intrusion or extrusion message but would be used for other “like messages” where the criteria for “like” is an analysis trigger parameter that can be dynamically installed in the trigger monitoring system.

In one embodiment, for each detected suspect message the at least part of the message data making up the suspect message is decrypted and decrypted suspect message copy data is generated representing a decrypted copy of at least part of the message data making up the suspect message.

In one embodiment, the suspect message copy data is then transmitted to one or more analysis systems for further analysis in an “off-line” environment. In one embodiment, the suspect message copy data is transmitted to the one or more analysis systems via a message analysis communication channel, also referred to herein as a second communications channel, that is distinct from the network communications channel, i.e., the first communications channel through which messages are relayed to, and/or from, the virtual assets via the network communications device. In this way, the transmission of the suspect message copy data, and the subsequent message data analysis, does not affect the operation of the virtual assets, and/or the operation of the cloud computing environment associated with the virtual assets.

As seen in FIG. 1, message copy data 219 is sent to analysis system 161, illustratively shown in computing environment 12 in FIG. 1, via message analysis channel 160, also referred to as the second communications channel. Referring back to FIG. 1 and FIG. 2 together, if analysis trigger monitor 215 detects one of the analysis trigger parameters of analysis trigger data 213 in message data 119, message data 119 is classified as suspect message data and this information is provided to message copy generation module 220 where suspect message copy data, represented in FIG. 1 by message copy data 219, is generated and transmitted to analysis system 161, i.e., a malware detection and analysis system, via message analysis channel 160 that is distinct from network communications channel 114.

In one embodiment, message copy data 219 is then provided to analysis module 163 of analysis system 161. As seen in FIG. 1, analysis system 161 is illustratively shown as being implemented in computing environment 12. As noted above, the implementation of analysis system 161 in computing environment 12 is shown for illustrative purposes only and, in other embodiments, analysis system 161 could be implemented in computing environment 10 or computing environment 11, or partially implemented in any of computing environment 10, computing environment 11, and computing environment 12.

In one embodiment, results data 165 is generated by analysis system 161 indicating the results of the analysis of the message copy data 219 by analysis module 163.

In one embodiment, multiple analysis systems, such as representative analysis system 160, are provided that are specifically implemented to analyze specific analysis trigger parameters. Consequently, in one embodiment, the particular analysis system to which a given example of suspect message data is transmitted is determined, at least in part, by the specific analysis trigger parameter detected in the suspect message from which the suspect message copy data was derived. Consequently, in one embodiment, the matching trigger data is used, at least in part, to determine which analysis system, such as representative analysis system 161, of one or more specialized analysis systems (not shown) is to receive message copy data 219 via message analysis channel 160.

In one embodiment, if, as a result of the analysis of the suspect message copy data by one or more of the analysis systems, it is determined that the suspect message is indeed associated with an intrusion or extrusion attack, one or more systems, entities, and/or parties, are alerted to the situation so that appropriate protective action can be taken.

In one embodiment, if, as a result of the analysis of the suspect message copy data by one or more of the analysis systems, it is determined that the suspect message is indeed associated with an intrusion or extrusion attack, one or more protective actions are automatically taken to prevent further infection of the virtual assets, and/or other virtual assets, and/or the application, service, infrastructure, or computing environment, associated with the now identified infected virtual asset.

In various embodiments, the protective actions taken can include, but are not limited to, isolating the virtual asset such that the virtual asset can still continue to operate, but in total isolation of all other virtual assets; partially isolating the virtual asset such that the virtual asset is allowed to connect to some very specific virtual assets, but has most of its communication channels blocked; “killing” or terminating the virtual asset; repairing the virtual asset by re-loading the compromised sub-components of the virtual asset; and/or any other protective actions, or combination of protective actions, discussed herein, and/or as known in the art at the time of filing, and/or as developed, or become known, after the time of filing.

Using the methods and systems for extrusion, and/or intrusion, detection in a cloud computing environment using network communications devices discussed above, intrusion and extrusion attacks in cloud computing environments can be detected using largely existing cloud computing environment infrastructure, such as network communication devices with added analysis trigger monitoring systems; without the need for devoting extensive and/or specialized resources. Consequently, using the method and system for extrusion, and/or intrusion, detection in a cloud computing environment, intrusion and extrusion events can be efficiently and effectively detected; thereby making distributed computing environments, such as cloud computing environments, more secure.

### Process

In accordance with one embodiment, a process for extrusion detection in a cloud computing environment using network communications devices includes providing one or more cloud computing environments. In one embodiment, each cloud computing environment includes one or more virtual assets. In one embodiment, each of the one or more cloud computing environments is provided at least one network communications device that receives, and/or relays, message traffic sent over a network communication channel from any of the one or more virtual assets included in the cloud computing environment.

In one embodiment, an analysis trigger monitoring system is provided for the network communications device. In one embodiment, one or more analysis trigger parameters are defined and analysis trigger data representing the analysis trigger parameters is generated. In one embodiment, the analysis trigger data is provided to the analysis trigger monitoring system for at least one communication device associated with each cloud computing environment. The analysis trigger monitoring system and the analysis trigger data are then used to monitor at least a portion of the message traffic sent through the network communications channel and the network communications device from each of the one or more virtual assets in the cloud computing environment assigned to the analysis trigger monitoring system to detect any message including one or more of the one or more analysis trigger parameters.

In one embodiment, any detected message including one or more of the one or more analysis trigger parameters is identified as a suspect message and, for each suspect message, suspect message copy data representing a copy of at least a portion of the suspect message is generated. In one embodiment, the suspect message copy data is then transferred to one or more analysis systems for further analysis.

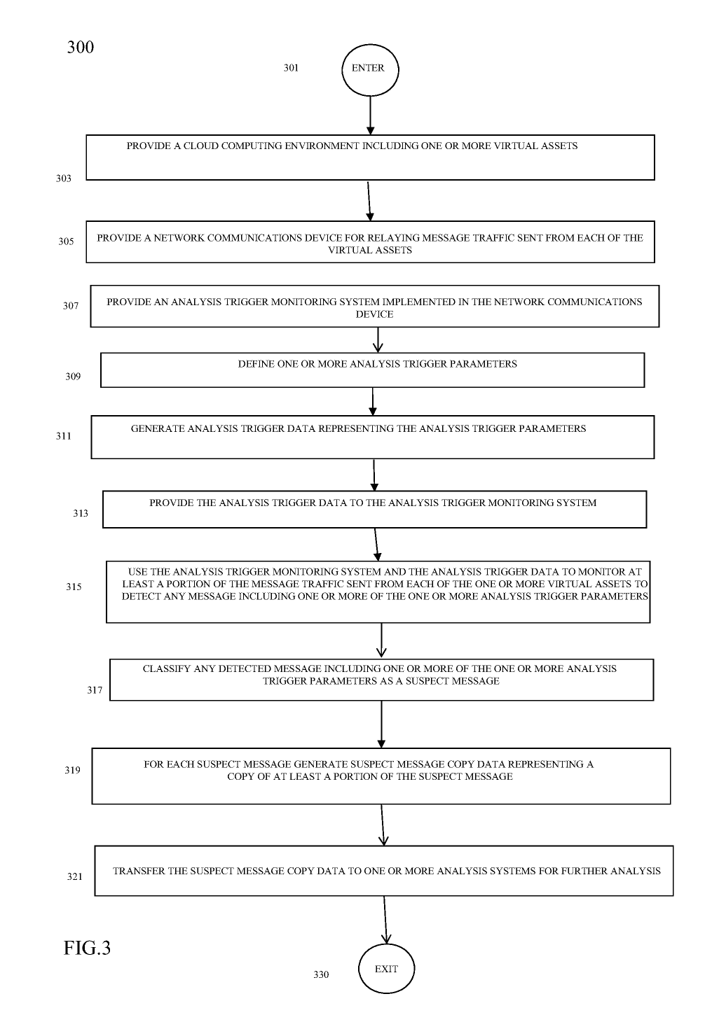

FIG. 3 is a flow chart of a process 300 for extrusion detection in a cloud computing environment using network communications devices in accordance with one embodiment. In one embodiment, process 300 for extrusion detection in a cloud computing environment using network communications devices begins at ENTER OPERATION 301 of FIG. 3 and process flow proceeds to PROVIDE A CLOUD COMPUTING ENVIRONMENT INCLUDING ONE OR MORE VIRTUAL ASSETS OPERATION 303.

In one embodiment, at PROVIDE A CLOUD COMPUTING ENVIRONMENT INCLUDING ONE OR MORE VIRTUAL ASSETS OPERATION 303 a cloud computing environment is provided.

In various embodiments, the cloud computing environment of PROVIDE A CLOUD COMPUTING ENVIRONMENT INCLUDING ONE OR MORE VIRTUAL ASSETS OPERATION 303 can be any form of cloud computing environment, such as, but not limited to, a Virtual Private Cloud, or VPC.

VPCs typically include configurable pools of shared computing resources, e.g., virtual assets, allocated to the VPC within a public cloud computing environment. In general, VPC's provide a level of isolation between different organizations, i.e., cloud users, using the resources. In general, VPC's are most commonly used in the context of cloud infrastructure services. In this context, the cloud computing infrastructure provider providing the underlying public cloud infrastructure, and the provider of the VPC over this infrastructure, may be different parties.

In many cases, a given application or service provided through a cloud computing infrastructure may utilize, and interface with, multiple cloud computing environments, including multiple VPCs, in the course of providing the associated service. As noted above, each cloud computing environment includes allocated virtual assets associated with, and controlled or used by, the party utilizing the cloud computing environment.

As used herein, the term “virtual asset” includes any virtualized entity or resource, and/or part of an actual, or “bare metal” entity requiring access to various resources, and types of resources. In various embodiments, the virtual assets can be, but are not limited to, virtual machines, virtual servers, and instances implemented in a cloud computing environment; databases implemented, or associated with, a cloud computing environment, and/or instances implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc. requiring access to various resources, and/or types of resources, located within a data center, within a cloud computing environment, and/or any other physical or logical location, as discussed herein, and/or as known/available in the art at the time of filing, and/or as developed/made available after the time of filing.

In one embodiment, virtual asset creation data is generated through a virtual asset creation system such as a virtual asset template through which the creator of a virtual asset can generate operational logic and assign resources and attributes to the virtual assets to be instantiated in a cloud computing environment, such as a virtual private cloud computing environment.

In one embodiment, once a cloud computing environment is provided at PROVIDE A CLOUD COMPUTING ENVIRONMENT INCLUDING ONE OR MORE VIRTUAL ASSETS OPERATION 303, process flow proceeds to PROVIDE A NETWORK COMMUNICATIONS DEVICE FOR RELAYING MESSAGE TRAFFIC SENT FROM EACH OF THE VIRTUAL ASSETS OPERATION 305.

In one embodiment, at PROVIDE A NETWORK COMMUNICATIONS DEVICE FOR RELAYING MESSAGE TRAFFIC SENT FROM EACH OF THE VIRTUAL ASSETS OPERATION 305 a network communications device is provided for each cloud computing environment of PROVIDE A CLOUD COMPUTING ENVIRONMENT INCLUDING ONE OR MORE VIRTUAL ASSETS OPERATION 303.

In various embodiments, the network communications devices of PROVIDE A NETWORK COMMUNICATIONS DEVICE FOR RELAYING MESSAGE TRAFFIC SENT FROM EACH OF THE VIRTUAL ASSETS OPERATION 305 provided for the cloud computing environment of PROVIDE A CLOUD COMPUTING ENVIRONMENT INCLUDING ONE OR MORE VIRTUAL ASSETS OPERATION 303 include, but are not limited to, one or more of a switching system, such as a network switch; a router; a border router; any gateway system; a firewall system; a load balancing system; or any communication, relay, or routing system, as discussed herein, and/or as known in the art at the time of filing, and/or as developed after the time of filing, through which message traffic on a network communications channel to, or from, an external network, such as the Internet, is relayed, and/or routed, to one or more virtual assets in a cloud computing environment.

In one embodiment, outgoing message traffic sent from one or more of the virtual assets associated with a given cloud computing environment of PROVIDE A CLOUD COMPUTING ENVIRONMENT INCLUDING ONE OR MORE VIRTUAL ASSETS OPERATION 303 to a destination external to the cloud computing environment, such as the Internet, is relayed through the network communications device for that cloud computing environment of PROVIDE A NETWORK COMMUNICATIONS DEVICE FOR RELAYING MESSAGE TRAFFIC SENT FROM EACH OF THE VIRTUAL ASSETS OPERATION 305.

In some embodiments, the network communications device of PROVIDE A NETWORK COMMUNICATIONS DEVICE FOR RELAYING MESSAGE TRAFFIC SENT FROM EACH OF THE VIRTUAL ASSETS OPERATION 305 utilizes an existing type of virtual asset that is then modified through the network communications device of PROVIDE A NETWORK COMMUNICATIONS DEVICE FOR RELAYING MESSAGE TRAFFIC SENT FROM EACH OF THE VIRTUAL ASSETS OPERATION 305 to add functionality for reviewing message traffic, as discussed below.

In one embodiment, the outgoing message traffic is relayed through the network communications device of PROVIDE A NETWORK COMMUNICATIONS DEVICE FOR RELAYING MESSAGE TRAFFIC SENT FROM EACH OF THE VIRTUAL ASSETS OPERATION 305 via at least one communications channel, e.g., a network communications channel, herein also referred to as a first communications channel.

As noted above, in various embodiments, the outgoing message traffic from the virtual assets associated with a given cloud computing environment are susceptible to the introduction of malware and, in particular, extrusion related malware.

In one embodiment, once a network communications device is included with each cloud computing environment provided at PROVIDE A NETWORK COMMUNICATIONS DEVICE FOR RELAYING MESSAGE TRAFFIC SENT FROM EACH OF THE VIRTUAL ASSETS OPERATION 305, process flow proceeds to PROVIDE AN ANALYSIS TRIGGER MONITORING SYSTEM IMPLEMENTED IN THE NETWORK COMMUNICATIONS DEVICE OPERATION 307.

As noted above, in various embodiments, the outgoing message traffic from the virtual assets associated with a given cloud computing environment of PROVIDE A CLOUD COMPUTING ENVIRONMENT INCLUDING ONE OR MORE VIRTUAL ASSETS OPERATION 303 are susceptible to the introduction of malware and, in particular, extrusion related malware.

As also noted above, the fact that malware can be introduced into the cloud computing environments of PROVIDE A CLOUD COMPUTING ENVIRONMENT INCLUDING ONE OR MORE VIRTUAL ASSETS OPERATION 303 is a long standing problem. As also noted above, some forms of malware take control of some, or all, of the infected virtual asset functionality and use the virtual asset to send outgoing messages and data through the message traffic relayed by the network communications device. This outbound malware mechanism is referred to as extrusion.

Consequently, the detection of malware extrusion is an important part of making the cloud computing environments of PROVIDE A CLOUD COMPUTING ENVIRONMENT INCLUDING ONE OR MORE VIRTUAL ASSETS OPERATION 303 more secure. However, as also noted above, a given cloud computing environment, and/or virtual private cloud computing environment, can include hundreds, thousands, or even millions, of virtual assets, owned or used by hundreds, thousands, or even millions, of parties. Consequently, detecting malware extrusion in a cloud computing environment is currently an extremely difficult and resource intensive task.

To address this issue, in one embodiment, the network communications device of PROVIDE A NETWORK COMMUNICATIONS DEVICE FOR RELAYING MESSAGE TRAFFIC SENT FROM EACH OF THE VIRTUAL ASSETS OPERATION 305 assigned to each cloud computing environment of PROVIDE A CLOUD COMPUTING ENVIRONMENT INCLUDING ONE OR MORE VIRTUAL ASSETS OPERATION 303, and relaying all outgoing message traffic, is provided an analysis trigger monitoring system at PROVIDE AN ANALYSIS TRIGGER MONITORING SYSTEM IMPLEMENTED IN THE NETWORK COMMUNICATIONS DEVICE OPERATION 307.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 307 is a module of software, and/or firmware, and/or hardware, capable of monitoring at least a portion of the message traffic from virtual assets instantiated in a given cloud computing environment of PROVIDE A CLOUD COMPUTING ENVIRONMENT INCLUDING ONE OR MORE VIRTUAL ASSETS OPERATION 303.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 307 is a module of software implemented within the network communications device assigned to a cloud computing environment.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 307 is firmware implemented within the network communications device assigned to a cloud computing environment.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 307 is an Application Specific Integrated Circuit (ASIC) implemented within, or associated with, the network communications device assigned to a cloud computing environment.

In various embodiments, process 300 for extrusion detection discussed herein is applied to network communications, e.g., message traffic, which is in plain text or is encrypted. Consequently, in some embodiments, the analysis trigger monitoring system of PROVIDE AN ANALYSIS TRIGGER MONITORING SYSTEM IMPLEMENTED IN THE NETWORK COMMUNICATIONS DEVICE OPERATION 307 includes a decryption capability to decrypt outgoing message traffic as part of the monitoring and analysis. In other embodiments, a decryption capability is provided to decrypt outgoing and incoming message traffic prior to the analysis trigger monitoring system of PROVIDE AN ANALYSIS TRIGGER MONITORING SYSTEM IMPLEMENTED IN THE NETWORK COMMUNICATIONS DEVICE OPERATION 307 and any monitoring and analysis.

As discussed below, in some embodiments, the analysis trigger monitoring system of PROVIDE AN ANALYSIS TRIGGER MONITORING SYSTEM IMPLEMENTED IN THE NETWORK COMMUNICATIONS DEVICE OPERATION 307 allows for analysis policies to be added, or removed, dynamically based on alerts that are received.

In one embodiment, once the network communications device of PROVIDE A NETWORK COMMUNICATIONS DEVICE FOR RELAYING MESSAGE TRAFFIC SENT FROM EACH OF THE VIRTUAL ASSETS OPERATION 305 assigned to each cloud computing environment of PROVIDE A CLOUD COMPUTING ENVIRONMENT INCLUDING ONE OR MORE VIRTUAL ASSETS OPERATION 303, and relaying all outgoing message traffic, is provided an analysis trigger monitoring system at PROVIDE AN ANALYSIS TRIGGER MONITORING SYSTEM IMPLEMENTED IN THE NETWORK COMMUNICATIONS DEVICE OPERATION 307, process flow proceeds to DEFINE ONE OR MORE ANALYSIS TRIGGER PARAMETERS OPERATION 309.

In one embodiment, at DEFINE ONE OR MORE ANALYSIS TRIGGER PARAMETERS OPERATION 309 one or more analysis trigger parameters are defined such that if one or more of the one or more analysis trigger parameters are detected in a message from a virtual asset, then that message is deemed a suspect message that is potentially associated with an extrusion attack on the virtual asset, and/or the cloud computing environment.

In various embodiments, the analysis trigger parameters of DEFINE ONE OR MORE ANALYSIS TRIGGER PARAMETERS OPERATION 309 can be dynamically added, removed, and/or modified to reflect various policies, and/or policy changes, made in response to malware alerts. In addition, as discussed below, in one embodiment, analysis trigger parameters are applied heuristically and new analysis trigger parameters that are discovered by the application of process 300 for extrusion detection in a cloud computing environment using network communications devices are added to create a self-learning extrusion detection system.

In various embodiments, specific examples of analysis trigger parameters of DEFINE ONE OR MORE ANALYSIS TRIGGER PARAMETERS OPERATION 309 include, but are not limited to, the presence of an IP address in a message indicating a designated suspect destination. In one embodiment, this analysis trigger parameter is used to detect messages going to a designated suspicious entity that is suspected of being associated with malware. In various embodiments, the IP addresses associated with designated suspicious entities, and/or the identity of the entities themselves, is provided by one or more third parties via alerts or other mechanisms.

In various embodiments, specific examples of analysis trigger parameters of DEFINE ONE OR MORE ANALYSIS TRIGGER PARAMETERS OPERATION 309 include, but are not limited to, the presence of an IP address in a message indicating a designated suspect geographical region. In one embodiment, this analysis trigger parameter is used to detect messages going to geographical locations that are known to be associated with malware. In various embodiments, the geographical locations known to be associated with malware are provided by the one or more third parties via alerts or other mechanisms.

In various embodiments, specific examples of analysis trigger parameters of DEFINE ONE OR MORE ANALYSIS TRIGGER PARAMETERS OPERATION 309 include, but are not limited to, the presence of an IP address in a message indicating a destination that is not included on a list of authorized, or expected, destinations of messages transmitted from the virtual assets. In one embodiment, this analysis trigger parameter is used to detect message traffic that would not be expected to be generated in the normal course of operation of the virtual assets according to their operational mission.

In various embodiments, specific examples of analysis trigger parameters of DEFINE ONE OR MORE ANALYSIS TRIGGER PARAMETERS OPERATION 309 include, but are not limited to, the presence of an IP address in a message indicating a geographical location that is not included on a list of authorized, or expected, geographical locations to be associated with messages to be transmitted from the virtual assets. In one embodiment, this analysis trigger parameter is used to detect message traffic that would not be expected to be generated in the normal course of operation of the virtual assets according to their operational instructions.

In various embodiments, specific examples of analysis trigger parameters of DEFINE ONE OR MORE ANALYSIS TRIGGER PARAMETERS OPERATION 309 include, but are not limited to, setting a threshold maximum message size and determining that a given message is of a size exceeding the threshold maximum message size. In one embodiment, this analysis trigger parameter takes advantage of the fact that many forms of malware require message sizes larger than those normally associated with a given virtual asset in order to deliver the malware necessary to execute the malicious intent.

In various embodiments, specific examples of analysis trigger parameters of DEFINE ONE OR MORE ANALYSIS TRIGGER PARAMETERS OPERATION 309 include, but are not limited to, setting a threshold minimum message size and determining that a given message is of a size that is less than the threshold minimum message size. In one embodiment, this analysis trigger is used to detect messages of a size that is smaller than a message size determined to be typical with respect to a given virtual asset, and that are therefore suspicious.

In various embodiments, specific examples of analysis trigger parameters of DEFINE ONE OR MORE ANALYSIS TRIGGER PARAMETERS OPERATION 309 include, but are not limited to, analysis trigger parameters based on frequency analysis of the access pattern indicating that messages arrive too frequently or too infrequently.

In various embodiments, specific examples of analysis trigger parameters of DEFINE ONE OR MORE ANALYSIS TRIGGER PARAMETERS OPERATION 309 include, but are not limited to, a hash value of at least part of the message data that is not included in a list of allowed hash values. In one embodiment, this analysis trigger parameter is used in conjunction with a hash-based analysis of at least part of a given message being transmitted from a virtual asset. In one embodiment, allowable hash values are defined and then a hash is performed on at least part of a given message. In one embodiment, if the hash of the portion of the given message does not match any of the allowed hash values, the message is determined to be suspect.

In various embodiments, specific examples of analysis trigger parameters of DEFINE ONE OR MORE ANALYSIS TRIGGER PARAMETERS OPERATION 309 include, but are not limited to, an MD5 value of the message data that is not included in a list of allowed MD5 values.

MD5 (Message-Digest algorithm five) is a widely used cryptographic hash function producing a 128 bit (16 byte) hash value that is typically expressed as a 32 digit hexadecimal number. In one embodiment, the MD5 algorithm is applied to at least part of the message data associated with a given message and the resulting MD5 value is compared with a list of allowed MD5 values. If the resulting MD5 value does not match any of the allowed MD5 values, then the message is considered suspect.

In various embodiments, specific examples of analysis trigger parameters of DEFINE ONE OR MORE ANALYSIS TRIGGER PARAMETERS OPERATION 309 include, but are not limited to, the specific identity of the sender of the message and adding the ability to have a per-message offline analysis that determines whether to trigger a message as suspect. In one embodiment, the analysis can be in-line or asynchronously off-line and would typically miss an initial or first example of an extrusion message but would be used for other “like messages” where the criteria for “like” is an analysis trigger parameter that can be dynamically installed in the trigger monitoring system. In addition, as discussed below, in one embodiment, analysis trigger parameters are applied heuristically and new analysis trigger parameters that are discovered by the application of process 300 for extrusion detection in a cloud computing environment using network communications devices are added to create a self-learning extrusion detection system.

In various embodiments, specific examples of analysis trigger parameters of DEFINE ONE OR MORE ANALYSIS TRIGGER PARAMETERS OPERATION 309 include, but are not limited to, the specific identity of the recipient of the message and adding the ability to have a per-message offline analysis that determines whether to trigger a message as suspect. In one embodiment, the analysis can be in-line or asynchronously off-line and would typically miss an initial or first example of an extrusion message but would be used for other “like messages” where the criteria for “like” is an analysis trigger parameter that can be dynamically installed in the trigger monitoring system. In addition, as discussed below, in one embodiment, analysis trigger parameters are applied heuristically and new analysis trigger parameters that are discovered by the application of process 300 for extrusion detection in a cloud computing environment using network communications devices are added to create a self-learning extrusion detection system.

In various other embodiments, any other analysis trigger parameter, or combination of analysis trigger parameters, as discussed herein, and/or as known in the art at the time of filing, and/or as developed after the time of filing is/are defined at DEFINE ONE OR MORE ANALYSIS TRIGGER PARAMETERS OPERATION 309.

As noted above, in one embodiment, analysis trigger parameters are applied heuristically and new analysis trigger parameters that are discovered by the application of process 300 for extrusion detection in a cloud computing environment using network communications devices are added to create a self-learning extrusion detection system.

In one embodiment, once one or more analysis trigger parameters are defined at DEFINE ONE OR MORE ANALYSIS TRIGGER PARAMETERS OPERATION 309, process flow proceeds to GENERATE ANALYSIS TRIGGER DATA REPRESENTING THE ANALYSIS TRIGGER PARAMETERS OPERATION 311.

In one embodiment, at GENERATE ANALYSIS TRIGGER DATA REPRESENTING THE ANALYSIS TRIGGER PARAMETERS OPERATION 311 machine-readable analysis trigger data is generated representing the analysis trigger parameters of DEFINE ONE OR MORE ANALYSIS TRIGGER PARAMETERS OPERATION 309.

In one embodiment, once machine-readable analysis trigger data is generated representing the analysis trigger parameters of DEFINE ONE OR MORE ANALYSIS TRIGGER PARAMETERS OPERATION 309 at GENERATE ANALYSIS TRIGGER DATA REPRESENTING THE ANALYSIS TRIGGER PARAMETERS OPERATION 311, process flow proceeds PROVIDE THE ANALYSIS TRIGGER DATA TO THE ANALYSIS TRIGGER MONITORING SYSTEM OPERATION 313.

In one embodiment, at PROVIDE THE ANALYSIS TRIGGER DATA TO THE ANALYSIS TRIGGER MONITORING SYSTEM OPERATION 313 the analysis trigger data of GENERATE ANALYSIS TRIGGER DATA REPRESENTING THE ANALYSIS TRIGGER PARAMETERS OPERATION 311 is provided to the analysis trigger monitoring system of PROVIDE A NETWORK COMMUNICATIONS DEVICE FOR RELAYING MESSAGE TRAFFIC SENT FROM EACH OF THE VIRTUAL ASSETS OPERATION 305 associated with the network communications device controlling the virtual assets of PROVIDE A CLOUD COMPUTING ENVIRONMENT INCLUDING ONE OR MORE VIRTUAL ASSETS OPERATION 303.

In one embodiment, once the analysis trigger data of GENERATE ANALYSIS TRIGGER DATA REPRESENTING THE ANALYSIS TRIGGER PARAMETERS OPERATION 311 is provided to the analysis trigger monitoring system of PROVIDE A NETWORK COMMUNICATIONS DEVICE FOR RELAYING MESSAGE TRAFFIC SENT FROM EACH OF THE VIRTUAL ASSETS OPERATION 305 associated with the network communications device controlling the virtual assets of PROVIDE A CLOUD COMPUTING ENVIRONMENT INCLUDING ONE OR MORE VIRTUAL ASSETS OPERATION 303 at PROVIDE THE ANALYSIS TRIGGER DATA TO THE ANALYSIS TRIGGER MONITORING SYSTEM OPERATION 313, process flow proceeds to USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 the analysis trigger data of GENERATE ANALYSIS TRIGGER DATA REPRESENTING THE ANALYSIS TRIGGER PARAMETERS OPERATION 311 and the analysis trigger monitoring system of PROVIDE A NETWORK COMMUNICATIONS DEVICE FOR RELAYING MESSAGE TRAFFIC SENT FROM EACH OF THE VIRTUAL ASSETS OPERATION 305 are used to monitor at least part of the message data associated with at least some of the message traffic from the virtual assets relayed through the network communications device of PROVIDE A NETWORK COMMUNICATIONS DEVICE FOR RELAYING MESSAGE TRAFFIC SENT FROM EACH OF THE VIRTUAL ASSETS OPERATION 305.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 the at least part of the message data associated with at least some of the message traffic from the virtual assets is decrypted by the decryption capability associated with the analysis trigger monitoring system of PROVIDE A NETWORK COMMUNICATIONS DEVICE FOR RELAYING MESSAGE TRAFFIC SENT FROM EACH OF THE VIRTUAL ASSETS OPERATION 305 before the analysis trigger data of GENERATE ANALYSIS TRIGGER DATA REPRESENTING THE ANALYSIS TRIGGER PARAMETERS OPERATION 311 and the analysis trigger monitoring system of PROVIDE A NETWORK COMMUNICATIONS DEVICE FOR RELAYING MESSAGE TRAFFIC SENT FROM EACH OF THE VIRTUAL ASSETS OPERATION 305 are used to monitor at least part of the message data associated with at least some of the message traffic from the virtual assets relayed through the network communications device of PROVIDE A NETWORK COMMUNICATIONS DEVICE FOR RELAYING MESSAGE TRAFFIC SENT FROM EACH OF THE VIRTUAL ASSETS OPERATION 305.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 a sample part of the message data associated with at least some of the message traffic from the virtual assets is monitored to detect one or more of the one or more analysis trigger parameters within the message data.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 all of the message data associated with at least part of the message traffic from the virtual assets is monitored to detect one or more of the one or more analysis trigger parameters within the message data.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 at least part of the message data associated with all of the message traffic from the virtual assets is monitored to detect one or more of the one or more analysis trigger parameters within the message data.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 all of the message data associated with all of the message traffic from the virtual assets is monitored to detect one or more of the one or more analysis trigger parameters within the message data.

In one embodiment, the analysis of USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 is performed by the analysis trigger monitoring system in-line, or asynchronously off-line, on a per-message basis. Consequently, in some embodiments, an initial or first example of an extrusion message is passed through but would be used to stop other “like messages” where the criteria for “like” is an analysis trigger parameter that can be dynamically installed in the trigger monitoring system.

In addition, in one embodiment, analysis trigger parameters are applied heuristically at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 and new analysis trigger parameters that are discovered by the application of process 300 for extrusion detection in a cloud computing environment using network communications devices are added to create a self-learning extrusion detection system.

In one embodiment, once the analysis trigger data of GENERATE ANALYSIS TRIGGER DATA REPRESENTING THE ANALYSIS TRIGGER PARAMETERS OPERATION 311 and the analysis trigger monitoring system of PROVIDE A NETWORK COMMUNICATIONS DEVICE FOR RELAYING MESSAGE TRAFFIC SENT FROM EACH OF THE VIRTUAL ASSETS OPERATION 305 are used to monitor at least part of the message data associated with at least some of the message traffic from the virtual assets relayed through the network communications device of USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315, process flow proceeds to CLASSIFY ANY DETECTED MESSAGE INCLUDING ONE OR MORE OF THE ONE OR MORE ANALYSIS TRIGGER PARAMETERS AS A SUSPECT MESSAGE OPERATION 317.

In one embodiment, at CLASSIFY ANY DETECTED MESSAGE INCLUDING ONE OR MORE OF THE ONE OR MORE ANALYSIS TRIGGER PARAMETERS AS A SUSPECT MESSAGE OPERATION 317, if one or more of the one or more analysis trigger parameters of DEFINE ONE OR MORE ANALYSIS TRIGGER PARAMETERS OPERATION 309 is detected within the message data associated with a given message, the classification data associated with that message is transformed into classification data indicating that the detected message including one or more of the one or more analysis trigger parameters is a suspect message.

In one embodiment, once the classification data associated with messages having one or more of the one or more analysis trigger parameters of DEFINE ONE OR MORE ANALYSIS TRIGGER PARAMETERS OPERATION 309 is transformed into classification data indicating that the detected message including one or more of the one or more analysis trigger parameters is a suspect message at CLASSIFY ANY DETECTED MESSAGE INCLUDING ONE OR MORE OF THE ONE OR MORE ANALYSIS TRIGGER PARAMETERS AS A SUSPECT MESSAGE OPERATION 317, process flow proceeds to FOR EACH SUSPECT MESSAGE GENERATE SUSPECT MESSAGE COPY DATA REPRESENTING A COPY OF AT LEAST A PORTION OF THE SUSPECT MESSAGE OPERATION 319.

In one embodiment, the detected suspect messages of CLASSIFY ANY DETECTED MESSAGE INCLUDING ONE OR MORE OF THE ONE OR MORE ANALYSIS TRIGGER PARAMETERS AS A SUSPECT MESSAGE OPERATION 317 are temporarily permitted to be transmitted from the virtual assets through the network communications channel with minimal delay.

In one embodiment, this transmission is permitted in order to avoid significantly disrupting or delaying the transmission of messages without further evidence that the suspect messages are indeed malicious. However, in one embodiment, at FOR EACH SUSPECT MESSAGE GENERATE SUSPECT MESSAGE COPY DATA REPRESENTING A COPY OF AT LEAST A PORTION OF THE SUSPECT MESSAGE OPERATION 319, for each detected suspect message of CLASSIFY ANY DETECTED MESSAGE INCLUDING ONE OR MORE OF THE ONE OR MORE ANALYSIS TRIGGER PARAMETERS AS A SUSPECT MESSAGE OPERATION 317, suspect message copy data is generated representing a copy of at least part of the message data making up the suspect message.

In one embodiment, for each detected suspect message of CLASSIFY ANY DETECTED MESSAGE INCLUDING ONE OR MORE OF THE ONE OR MORE ANALYSIS TRIGGER PARAMETERS AS A SUSPECT MESSAGE OPERATION 317, the at least part of the message data making up the suspect message is decrypted and decrypted suspect message copy data is generated representing a decrypted copy of at least part of the message data making up the suspect message at FOR EACH SUSPECT MESSAGE GENERATE SUSPECT MESSAGE COPY DATA REPRESENTING A COPY OF AT LEAST A PORTION OF THE SUSPECT MESSAGE OPERATION 319.

In one embodiment, once for each detected suspect message of CLASSIFY ANY DETECTED MESSAGE INCLUDING ONE OR MORE OF THE ONE OR MORE ANALYSIS TRIGGER PARAMETERS AS A SUSPECT MESSAGE OPERATION 317, suspect message copy data is generated representing a copy of at least part of the message data making up the suspect message at FOR EACH SUSPECT MESSAGE GENERATE SUSPECT MESSAGE COPY DATA REPRESENTING A COPY OF AT LEAST A PORTION OF THE SUSPECT MESSAGE OPERATION 319, process flow proceeds to TRANSFER THE SUSPECT MESSAGE COPY DATA TO ONE OR MORE ANALYSIS SYSTEMS FOR FURTHER ANALYSIS OPERATION 321.

In one embodiment, at TRANSFER THE SUSPECT MESSAGE COPY DATA TO ONE OR MORE ANALYSIS SYSTEMS FOR FURTHER ANALYSIS OPERATION 321, the suspect message copy data of FOR EACH SUSPECT MESSAGE GENERATE SUSPECT MESSAGE COPY DATA REPRESENTING A COPY OF AT LEAST A PORTION OF THE SUSPECT MESSAGE OPERATION 319 is transmitted to one or more analysis systems for further analysis in an “off-line” environment.

In one embodiment, at TRANSFER THE SUSPECT MESSAGE COPY DATA TO ONE OR MORE ANALYSIS SYSTEMS FOR FURTHER ANALYSIS OPERATION 321, the suspect message copy data of FOR EACH SUSPECT MESSAGE GENERATE SUSPECT MESSAGE COPY DATA REPRESENTING A COPY OF AT LEAST A PORTION OF THE SUSPECT MESSAGE OPERATION 319 is transmitted to the one or more analysis systems via a message analysis channel, also referred to herein as a second communications channel, that is distinct from the network communications channel, i.e., the first communications channel through which messages are transmitted from the virtual assets relayed by the network communications device of PROVIDE A CLOUD COMPUTING ENVIRONMENT INCLUDING ONE OR MORE VIRTUAL ASSETS OPERATION 303. In this way, the transmission of the suspect message copy data, and the subsequent message data analysis, does not affect the operation of the virtual asset, and/or the cloud computing environment, application, service, enterprise, and/or infrastructure associated with the virtual asset.

In one embodiment, multiple analysis systems are provided at TRANSFER THE SUSPECT MESSAGE COPY DATA TO ONE OR MORE ANALYSIS SYSTEMS FOR FURTHER ANALYSIS OPERATION 321 that are specifically implemented to analyze specific analysis trigger parameters of DEFINE ONE OR MORE ANALYSIS TRIGGER PARAMETERS OPERATION 309.

Consequently, in one embodiment, the particular analysis system to which a given example of suspect message data is transmitted at TRANSFER THE SUSPECT MESSAGE COPY DATA TO ONE OR MORE ANALYSIS SYSTEMS FOR FURTHER ANALYSIS OPERATION 321 is determined, at least in part, by the specific analysis trigger parameter detected in the suspect message at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 from which the suspect message copy data was derived at FOR EACH SUSPECT MESSAGE GENERATE SUSPECT MESSAGE COPY DATA REPRESENTING A COPY OF AT LEAST A PORTION OF THE SUSPECT MESSAGE OPERATION 319.

In one embodiment, if, as a result of the analysis of the suspect message copy data by one or more of the analysis systems at TRANSFER THE SUSPECT MESSAGE COPY DATA TO ONE OR MORE ANALYSIS SYSTEMS FOR FURTHER ANALYSIS OPERATION 321, it is determined that the suspect message is indeed associated with an extrusion attack, one or more systems, entities, and/or parties, are alerted to the situation so that appropriate protective action can be taken.

In one embodiment, if, as a result of the analysis of the suspect message copy data by one or more of the analysis systems at TRANSFER THE SUSPECT MESSAGE COPY DATA TO ONE OR MORE ANALYSIS SYSTEMS FOR FURTHER ANALYSIS OPERATION 321, it is determined that the suspect message is indeed associated with an extrusion attack, one or more protective actions are automatically taken to prevent further infection of the virtual assets, and/or other virtual assets, and/or the cloud computing environment, application, service, infrastructure, or computing environment, associated with the now identified infected virtual asset.

In various embodiments, the protective actions taken can include, but are not limited to, isolating the virtual asset such that the virtual asset can still continue to operate, but in total isolation of all other virtual assets; partially isolating the virtual asset such that the virtual asset is allowed to connect to some very specific virtual assets, but has most of its communication channels blocked; “killing” or terminating the virtual asset; repairing the virtual asset by re-loading the compromised sub-components of the virtual asset; and/or any other protective actions, or combination of protective actions, discussed herein, and/or as known in the art at the time of filing, and/or as developed, or become known, after the time of filing.

In addition, analysis trigger parameters are applied heuristically at USE THE ANALYSIS TRIGGER MONITORING SYSTEM AND THE ANALYSIS TRIGGER DATA TO MONITOR AT LEAST A PORTION OF THE MESSAGE TRAFFIC SENT FROM EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 315 and if, as a result of the analysis of the suspect message copy data by one or more of the analysis systems at TRANSFER THE SUSPECT MESSAGE COPY DATA TO ONE OR MORE ANALYSIS SYSTEMS FOR FURTHER ANALYSIS OPERATION 321, it is determined that the suspect message is indeed associated with an extrusion attack, new analysis trigger parameters that are thereby discovered by the application of process 300 for extrusion detection in a cloud computing environment using network communications devices are added at to create a self-learning extrusion detection system.

In one embodiment, once the suspect message copy data of FOR EACH SUSPECT MESSAGE GENERATE SUSPECT MESSAGE COPY DATA REPRESENTING A COPY OF AT LEAST A PORTION OF THE SUSPECT MESSAGE OPERATION 319 is transmitted to one or more analysis systems for further analysis in an “off-line” environment at TRANSFER THE SUSPECT MESSAGE COPY DATA TO ONE OR MORE ANALYSIS SYSTEMS FOR FURTHER ANALYSIS OPERATION 321, process flow proceeds to EXIT OPERATION 330.

In one embodiment, at EXIT OPERATION 330 process 300 for extrusion detection in a cloud computing environment using network communications devices is exited to await new data.

Using process 300 for extrusion detection in a cloud computing environment using network communications devices discussed above, extrusion attacks can be detected using largely existing cloud computing environment infrastructure, such as network communication devices with added analysis trigger monitoring systems; without the need for devoting extensive and/or specialized resources. Consequently, using process 300 for extrusion detection in a cloud computing environment using network communications devices, extrusion events can be efficiently and effectively detected; thereby making distributed computing environments, such as cloud computing environments, more secure.

In accordance with one embodiment, a process for intrusion detection in a cloud computing environment using network communications devices includes providing one or more cloud computing environments. In one embodiment, each cloud computing environment includes one or more virtual assets. In one embodiment, each of the one or more cloud computing environments is provided at least one network communications device that receives, and/or relays, message traffic sent over a network communication channel to any of the one or more virtual assets included in the cloud computing environment.

In one embodiment, an analysis trigger monitoring system is provided for the network communications device. In one embodiment, one or more analysis trigger parameters are defined and analysis trigger data representing the analysis trigger parameters is generated. In one embodiment, the analysis trigger data is provided to the analysis trigger monitoring system for at least one communication device associated with each cloud computing environment. The analysis trigger monitoring system and the analysis trigger data are then used to monitor at least a portion of the message traffic sent through the network communications channel and the network communications device to each of the one or more virtual assets in the cloud computing environment assigned to the analysis trigger monitoring system to detect any message including one or more of the one or more analysis trigger parameters.

In one embodiment, any detected message including one or more of the one or more analysis trigger parameters is identified as a suspect message and, for each suspect message, suspect message copy data representing a copy of at least a portion of the suspect message is generated. In one embodiment, the suspect message copy data is then transferred to one or more analysis systems for further analysis.

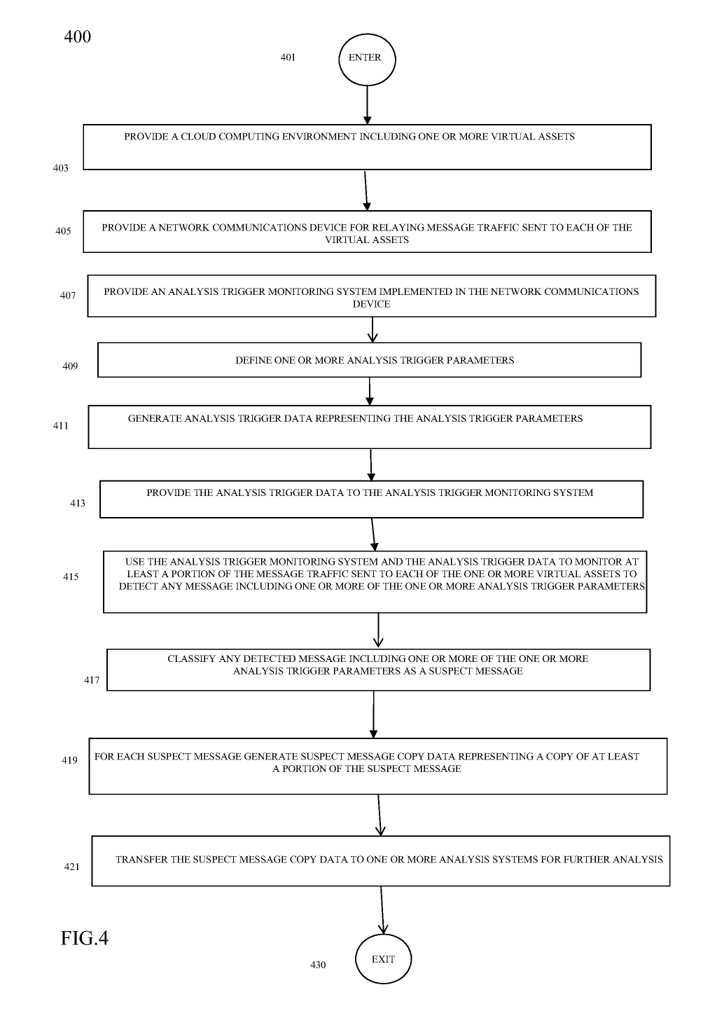

FIG. 4 is a flow chart of a process 400 for intrusion detection in a cloud computing environment using network communications devices in accordance with one embodiment. In one embodiment, process 400 for intrusion detection in a cloud computing environment using network communications devices begins at ENTER OPERATION 401 of FIG. 4 and process flow proceeds to PROVIDE A CLOUD COMPUTING ENVIRONMENT INCLUDING ONE OR MORE VIRTUAL ASSETS OPERATION 403.

In one embodiment, at PROVIDE A CLOUD COMPUTING ENVIRONMENT INCLUDING ONE OR MORE VIRTUAL ASSETS OPERATION 403 a cloud computing environment is provided.

In various embodiments, the cloud computing environment of PROVIDE A CLOUD COMPUTING ENVIRONMENT INCLUDING ONE OR MORE VIRTUAL ASSETS OPERATION 403 can be any form of cloud computing environment, such as, but not limited to, a Virtual Private Cloud, or VPC.

In many cases, a given application or service provided through a cloud computing infrastructure may utilize, and interface with, multiple cloud computing environments, including multiple VPCs, in the course of providing the associated service. As noted above, each cloud computing environment includes allocated virtual assets associated with, and controlled or used by, the party utilizing the cloud computing environment.

As used herein, the term “virtual asset” includes any virtualized entity or resource, and/or part of an actual, or “bare metal” entity requiring access to various resources, and types of resources. In various embodiments, the virtual assets can be, but are not limited to, virtual machines, virtual servers, and instances implemented in a cloud computing environment; databases implemented, or associated with, a cloud computing environment, and/or instances implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc. requiring access to various resources, and/or types of resources, located within a data center, within a cloud computing environment, and/or any other physical or logical location, as discussed herein, and/or as known/available in the art at the time of filing, and/or as developed/made available after the time of filing.

In one embodiment, virtual asset creation data is generated through a virtual asset creation system such as a virtual asset template through which the creator of a virtual asset can generate operational logic and assign resources and attributes to the virtual assets to be instantiated in a cloud computing environment, such as a virtual private cloud computing environment.

In one embodiment, once a cloud computing environment is provided at PROVIDE A CLOUD COMPUTING ENVIRONMENT INCLUDING ONE OR MORE VIRTUAL ASSETS OPERATION 403, process flow proceeds to PROVIDE A NETWORK COMMUNICATIONS DEVICE FOR RELAYING MESSAGE TRAFFIC SENT TO EACH OF THE VIRTUAL ASSETS OPERATION 405.

In one embodiment, at PROVIDE A NETWORK COMMUNICATIONS DEVICE FOR RELAYING MESSAGE TRAFFIC SENT TO EACH OF THE VIRTUAL ASSETS OPERATION 405 a network communications device is provided for each cloud computing environment of PROVIDE A CLOUD COMPUTING ENVIRONMENT INCLUDING ONE OR MORE VIRTUAL ASSETS OPERATION 403.

In various embodiments, the network communications devices of PROVIDE A NETWORK COMMUNICATIONS DEVICE FOR RELAYING MESSAGE TRAFFIC SENT TO EACH OF THE VIRTUAL ASSETS OPERATION 405 provided to the cloud computing environment of PROVIDE A CLOUD COMPUTING ENVIRONMENT INCLUDING ONE OR MORE VIRTUAL ASSETS OPERATION 403 include, but are not limited to, one or more of a switching system, such as a network switch; a router; a border router; any gateway system; a firewall system; a load balancing system; or any communication, relay, or routing system, as discussed herein, and/or as known in the art at the time of filing, and/or as developed after the time of filing, through which message traffic on a network communications channel to, or from, an external network, such as the Internet, is relayed, and/or routed, to one or more virtual assets in a cloud computing environment.

In one embodiment, incoming message traffic sent to one or more of the virtual assets associated with a given cloud computing environment of PROVIDE A CLOUD COMPUTING ENVIRONMENT INCLUDING ONE OR MORE VIRTUAL ASSETS OPERATION 403 from a destination external to the cloud computing environment, such as the Internet, is relayed through the network communications device for that cloud computing environment of PROVIDE A NETWORK COMMUNICATIONS DEVICE FOR RELAYING MESSAGE TRAFFIC SENT TO EACH OF THE VIRTUAL ASSETS OPERATION 405.

In some embodiments, the network communications device of PROVIDE A NETWORK COMMUNICATIONS DEVICE FOR RELAYING MESSAGE TRAFFIC SENT TO EACH OF THE VIRTUAL ASSETS OPERATION 405 utilizes an existing type of virtual asset that is then modified through the network communications device of PROVIDE A NETWORK COMMUNICATIONS DEVICE FOR RELAYING MESSAGE TRAFFIC SENT TO EACH OF THE VIRTUAL ASSETS OPERATION 405 to add functionality for reviewing message traffic, as discussed below.

In one embodiment, the incoming message traffic is relayed through the network communications device of PROVIDE A NETWORK COMMUNICATIONS DEVICE FOR RELAYING MESSAGE TRAFFIC SENT TO EACH OF THE VIRTUAL ASSETS OPERATION 405 via at least one communications channel, e.g., a network communications channel, herein also referred to as a first communications channel.

As noted above, in various embodiments, incoming message traffic to the virtual assets associated with a given cloud computing environment are susceptible to the introduction of malware and, in particular, intrusion related malware.

In one embodiment, once a network communications device is included with each cloud computing environment provided at PROVIDE A NETWORK COMMUNICATIONS DEVICE FOR RELAYING MESSAGE TRAFFIC SENT TO EACH OF THE VIRTUAL ASSETS OPERATION 405, process flow proceeds to PROVIDE AN ANALYSIS TRIGGER MONITORING SYSTEM IMPLEMENTED IN THE NETWORK COMMUNICATIONS DEVICE OPERATION 407.

As noted above, in various embodiments, the incoming message traffic from the virtual assets associated with a given cloud computing environment of PROVIDE A CLOUD COMPUTING ENVIRONMENT INCLUDING ONE OR MORE VIRTUAL ASSETS OPERATION 403 are susceptible to the introduction of malware and, in particular, intrusion related malware.

As also noted above, the fact that malware can be introduced into the cloud computing environments of PROVIDE A CLOUD COMPUTING ENVIRONMENT INCLUDING ONE OR MORE VIRTUAL ASSETS OPERATION 403 is a long standing problem. Consequently, the detection of malware intrusion is an important part of making the cloud computing environments of PROVIDE A CLOUD COMPUTING ENVIRONMENT INCLUDING ONE OR MORE VIRTUAL ASSETS OPERATION 403 more secure. However, as also noted above, a given cloud computing environment, and/or virtual private cloud computing environment, can include hundreds, thousands, or even millions, of virtual assets, owned or used by hundreds, thousands, or even millions, of parties. Consequently, detecting malware intrusion in a cloud computing environment is currently an extremely difficult and resource intensive task.

To address this issue, in one embodiment, the network communications device of PROVIDE A NETWORK COMMUNICATIONS DEVICE FOR RELAYING MESSAGE TRAFFIC SENT TO EACH OF THE VIRTUAL ASSETS OPERATION 405 assigned to each cloud computing environment of PROVIDE A CLOUD COMPUTING ENVIRONMENT INCLUDING ONE OR MORE VIRTUAL ASSETS OPERATION 403, and relaying all incoming message traffic, is provided an analysis trigger monitoring system at PROVIDE AN ANALYSIS TRIGGER MONITORING SYSTEM IMPLEMENTED IN THE NETWORK COMMUNICATIONS DEVICE OPERATION 407.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 407 is a module of software, and/or firmware, and/or hardware, capable of monitoring at least a portion of the message traffic to virtual assets instantiated in a given cloud computing environment of PROVIDE A CLOUD COMPUTING ENVIRONMENT INCLUDING ONE OR MORE VIRTUAL ASSETS OPERATION 403.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 407 is a module of software implemented within the network communications device assigned to a cloud computing environment.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 407 is firmware implemented within the network communications device assigned to a cloud computing environment.

In various embodiments, the analysis trigger monitoring system of PROVIDE AN ANALYSIS TRIGGER MONITORING SYSTEM IMPLEMENTED IN THE NETWORK COMMUNICATIONS DEVICE OPERATION 407 is an ASIC within, or associated with, the network communications device assigned to a cloud computing environment.

In various embodiments, process 400 for intrusion detection discussed herein is applied to network communications, e.g., message traffic, which is in plain text or is encrypted. Consequently, in some embodiments, the analysis trigger monitoring system of PROVIDE AN ANALYSIS TRIGGER MONITORING SYSTEM IMPLEMENTED IN THE NETWORK COMMUNICATIONS DEVICE OPERATION 407 includes a decryption capability to decrypt incoming message traffic as part of the monitoring and analysis. In other embodiments, a decryption capability is provided to decrypt incoming message traffic prior to the analysis trigger monitoring system of PROVIDE AN ANALYSIS TRIGGER MONITORING SYSTEM IMPLEMENTED IN THE NETWORK COMMUNICATIONS DEVICE OPERATION 407 and any monitoring and analysis.

As discussed below, in some embodiments, the analysis trigger monitoring system of PROVIDE AN ANALYSIS TRIGGER MONITORING SYSTEM IMPLEMENTED IN THE NETWORK COMMUNICATIONS DEVICE OPERATION 407 allows for analysis policies to be added, or removed, dynamically based on alerts. Consequently, in one embodiment, new analysis trigger parameters are discovered and applied heuristically to create a self-learning intrusion detection system.

In one embodiment, once the network communications device of PROVIDE A NETWORK COMMUNICATIONS DEVICE FOR RELAYING MESSAGE TRAFFIC SENT TO EACH OF THE VIRTUAL ASSETS OPERATION 405 assigned to each cloud computing environment of PROVIDE A CLOUD COMPUTING ENVIRONMENT INCLUDING ONE OR MORE VIRTUAL ASSETS OPERATION 403, and relaying all incoming message traffic, is provided an analysis trigger monitoring system at PROVIDE AN ANALYSIS TRIGGER MONITORING SYSTEM IMPLEMENTED IN THE NETWORK COMMUNICATIONS DEVICE OPERATION 407, process flow proceeds to DEFINE ONE OR MORE ANALYSIS TRIGGER PARAMETERS OPERATION 409.

In one embodiment, at DEFINE ONE OR MORE ANALYSIS TRIGGER PARAMETERS OPERATION 409 one or more analysis trigger parameters are defined such that if one or more of the one or more analysis trigger parameters are detected in a message to a virtual asset, then that message is deemed a suspect message that is potentially associated with an intrusion attack on the virtual asset, and/or the cloud computing environment.

In various embodiments, the analysis trigger parameters of DEFINE ONE OR MORE ANALYSIS TRIGGER PARAMETERS OPERATION 409 can be dynamically added, removed, and/or modified to reflect various policies, and/or policy changes made in response to malware alerts. In addition, as discussed below, in one embodiment, analysis trigger parameters are applied heuristically and new analysis trigger parameters that are discovered by the application of process 400 for intrusion detection in a cloud computing environment using network communications devices are added to create a self-learning intrusion detection system.

In various embodiments, specific examples of analysis trigger parameters of DEFINE ONE OR MORE ANALYSIS TRIGGER PARAMETERS OPERATION 409 include, but are not limited to, the presence of an IP address in a message indicating a designated suspect origin. In one embodiment, this analysis trigger parameter is used to detect messages coming from a designated suspicious entity that is suspected of being associated with malware. In various embodiments, the IP addresses associated with designated suspicious entities, and/or the identity of the entities themselves, is provided by one or more third parties via alerts or other mechanisms.

In various embodiments, specific examples of analysis trigger parameters of DEFINE ONE OR MORE ANALYSIS TRIGGER PARAMETERS OPERATION 409 include, but are not limited to, the presence of an IP address in a message indicating a designated suspect geographical region. In one embodiment, this analysis trigger parameter is used to detect messages coming from geographical locations that are known to be associated with malware. In various embodiments, the geographical locations known to be associated with malware are provided by the one or more third parties via alerts or other mechanisms.

In various embodiments, specific examples of analysis trigger parameters of DEFINE ONE OR MORE ANALYSIS TRIGGER PARAMETERS OPERATION 409 include, but are not limited to, the presence of an IP address in a message indicating an origin that is not included on a list of authorized, or expected, origins of messages transmitted to the virtual assets. In one embodiment, this analysis trigger parameter is used to detect message traffic that would not be expected to be received in the normal course of operation of the virtual assets according to their operational mission.

In various embodiments, specific examples of analysis trigger parameters of DEFINE ONE OR MORE ANALYSIS TRIGGER PARAMETERS OPERATION 409 include, but are not limited to, the presence of an IP address in a message indicating a geographical location that is not included on a list of authorized, or expected, geographical locations to be associated with messages to be transmitted to the virtual assets. In one embodiment, this analysis trigger parameter is used to detect message traffic that would not be expected to be received in the normal course of operation of the virtual assets according to their operational instructions.

In various embodiments, specific examples of analysis trigger parameters of DEFINE ONE OR MORE ANALYSIS TRIGGER PARAMETERS OPERATION 409 include, but are not limited to, setting a threshold maximum message size and determining that a given message is of a size exceeding the threshold maximum message size. In one embodiment, this analysis trigger parameter takes advantage of the fact that many forms of malware require message sizes larger than those normally associated with a given virtual asset in order to deliver the malware necessary to execute the malicious intent.

In various embodiments, specific examples of analysis trigger parameters of DEFINE ONE OR MORE ANALYSIS TRIGGER PARAMETERS OPERATION 409 include, but are not limited to, setting a threshold minimum message size and determining that a given message is of a size that is less than the threshold minimum message size. In one embodiment, this analysis trigger is used to detect messages of a size that is smaller than a message size determined to be typical with respect to a given virtual asset, and that are therefore suspicious.

In various embodiments, specific examples of analysis trigger parameters of DEFINE ONE OR MORE ANALYSIS TRIGGER PARAMETERS OPERATION 409 include, but are not limited to, analysis trigger parameters based on frequency analysis of the access pattern indicating that messages arrive too frequently or too infrequently.

In various embodiments, specific examples of analysis trigger parameters of DEFINE ONE OR MORE ANALYSIS TRIGGER PARAMETERS OPERATION 409 include, but are not limited to, a hash value of at least part of the message data that is not included in a list of allowed hash values. In one embodiment, this analysis trigger parameter is used in conjunction with a hash-based analysis of at least part of a given message being transmitted to a virtual asset. In one embodiment, allowable hash values are defined and then a hash is performed on at least part of a given message. In one embodiment, if the hash of the portion of the given message does not match any of the allowed hash values, the message is determined to be suspect.

In various embodiments, specific examples of analysis trigger parameters of DEFINE ONE OR MORE ANALYSIS TRIGGER PARAMETERS OPERATION 409 include, but are not limited to, an MD5 value of the message data that is not included in a list of allowed MD5 values.

MD5 (Message-Digest algorithm five) is a widely used cryptographic hash function producing a 128 bit (16 byte) hash value that is typically expressed as a 32 digit hexadecimal number. In one embodiment, the MD5 algorithm is applied to at least part of the message data associated with a given message and the resulting MD5 value is compared with a list of allowed MD5 values. If the resulting MD5 value does not match any of the allowed MD5 values, then the message is considered suspect.

In various embodiments, specific examples of analysis trigger parameters of DEFINE ONE OR MORE ANALYSIS TRIGGER PARAMETERS OPERATION 409 include, but are not limited to, the specific identity of the sender of the message and adding the ability to have a per-message offline analysis that determines whether to trigger a message as suspect. In one embodiment, the analysis can be in-line or asynchronously off-line and would typically miss an initial or first example of an intrusion message but would be used for other “like messages” where the criteria for “like” is an analysis trigger parameter that can be dynamically installed in the trigger monitoring system. In addition, as discussed below, in one embodiment, analysis trigger parameters are applied heuristically and new analysis trigger parameters that are discovered by the application of process 400 for intrusion detection in a cloud computing environment using network communications devices are added to create a self-learning intrusion detection system.

In various embodiments, specific examples of analysis trigger parameters of DEFINE ONE OR MORE ANALYSIS TRIGGER PARAMETERS OPERATION 409 include, but are not limited to, the specific identity of the recipient of the message and adding the ability to have a per-message offline analysis that determines whether to trigger a message as suspect. In one embodiment, the analysis can be in-line or asynchronously off-line and would typically miss an initial or first example of an intrusion message but would be used for other “like messages” where the criteria for “like” is an analysis trigger parameter that can be dynamically installed in the trigger monitoring system. In addition, as discussed below, in one embodiment, analysis trigger parameters are applied heuristically and new analysis trigger parameters that are discovered by the application of process 400 for intrusion detection in a cloud computing environment using network communications devices are added to create a self-learning intrusion detection system.

In various other embodiments, any other analysis trigger parameter, or combination of analysis trigger parameters, as discussed herein, and/or as known in the art at the time of filing, and/or as developed after the time of filing is/are defined at DEFINE ONE OR MORE ANALYSIS TRIGGER PARAMETERS OPERATION 409. In addition, as discussed below, in one embodiment, analysis trigger parameters are applied heuristically and new analysis trigger parameters that are discovered by the application of process 400 for intrusion detection in a cloud computing environment using network communications devices are added to create a self-learning intrusion detection system.

In one embodiment, once one or more analysis trigger parameters are defined at DEFINE ONE OR MORE ANALYSIS TRIGGER PARAMETERS OPERATION 409, process flow proceeds to GENERATE ANALYSIS TRIGGER DATA REPRESENTING THE ANALYSIS TRIGGER PARAMETERS OPERATION 411.

In one embodiment, at GENERATE ANALYSIS TRIGGER DATA REPRESENTING THE ANALYSIS TRIGGER PARAMETERS OPERATION 411 machine-readable analysis trigger data is generated representing the analysis trigger parameters of DEFINE ONE OR MORE ANALYSIS TRIGGER PARAMETERS OPERATION 409.

In one embodiment, once machine-readable analysis trigger data is generated representing the analysis trigger parameters of DEFINE ONE OR MORE ANALYSIS TRIGGER PARAMETERS OPERATION 409 at GENERATE ANALYSIS TRIGGER DATA REPRESENTING THE ANALYSIS TRIGGER PARAMETERS OPERATION 411, process flow proceeds PROVIDE THE ANALYSIS TRIGGER DATA TO THE ANALYSIS TRIGGER MONITORING SYSTEM OPERATION 413.

In one embodiment, at PROVIDE THE ANALYSIS TRIGGER DATA TO THE ANALYSIS TRIGGER MONITORING SYSTEM OPERATION 413 the analysis trigger data of GENERATE ANALYSIS TRIGGER DATA REPRESENTING THE ANALYSIS TRIGGER PARAMETERS OPERATION 411 is provided to the analysis trigger monitoring system of PROVIDE A NETWORK COMMUNICATIONS DEVICE FOR RELAYING MESSAGE TRAFFIC SENT TO EACH OF THE VIRTUAL ASSETS OPERATION 405 associated with the network communications device controlling the virtual assets of PROVIDE A CLOUD COMPUTING ENVIRONMENT INCLUDING ONE OR MORE VIRTUAL ASSETS OPERATION 403.

In one embodiment, once the analysis trigger data of GENERATE ANALYSIS TRIGGER DATA REPRESENTING THE ANALYSIS TRIGGER PARAMETERS OPERATION 411 is provided to the analysis trigger monitoring system of PROVIDE A NETWORK COMMUNICATIONS DEVICE FOR RELAYING MESSAGE TRAFFIC SENT TO EACH OF THE VIRTUAL ASSETS OPERATION 405 associated with the network communications device controlling the virtual assets of PROVIDE A CLOUD COMPUTING ENVIRONMENT INCLUDING ONE OR MORE VIRTUAL ASSETS OPERATION 403 at PROVIDE THE ANALYSIS TRIGGER DATA TO THE ANALYSIS TRIGGER MONITORING SYSTEM OPERATION 413, process flow proceeds to USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 the analysis trigger data of GENERATE ANALYSIS TRIGGER DATA REPRESENTING THE ANALYSIS TRIGGER PARAMETERS OPERATION 411 and the analysis trigger monitoring system of PROVIDE A NETWORK COMMUNICATIONS DEVICE FOR RELAYING MESSAGE TRAFFIC SENT TO EACH OF THE VIRTUAL ASSETS OPERATION 405 are used to monitor at least part of the message data associated with at least some of the message traffic to the virtual assets relayed through the network communications device of PROVIDE A NETWORK COMMUNICATIONS DEVICE FOR RELAYING MESSAGE TRAFFIC SENT TO EACH OF THE VIRTUAL ASSETS OPERATION 405.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 the at least part of the message data associated with at least some of the message traffic to the virtual assets is decrypted by the decryption capability associated with the analysis trigger monitoring system of PROVIDE A NETWORK COMMUNICATIONS DEVICE FOR RELAYING MESSAGE TRAFFIC SENT TO EACH OF THE VIRTUAL ASSETS OPERATION 405 before the analysis trigger data of GENERATE ANALYSIS TRIGGER DATA REPRESENTING THE ANALYSIS TRIGGER PARAMETERS OPERATION 411 and the analysis trigger monitoring system of PROVIDE A NETWORK COMMUNICATIONS DEVICE FOR RELAYING MESSAGE TRAFFIC SENT TO EACH OF THE VIRTUAL ASSETS OPERATION 405 are used to monitor at least part of the message data associated with at least some of the message traffic to the virtual assets relayed through the network communications device of PROVIDE A NETWORK COMMUNICATIONS DEVICE FOR RELAYING MESSAGE TRAFFIC SENT TO EACH OF THE VIRTUAL ASSETS OPERATION 405.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 a sample part of the message data associated with at least some of the message traffic to the virtual assets is monitored to detect one or more of the one or more analysis trigger parameters within the message data.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 all of the message data associated with at least part of the message traffic to the virtual assets is monitored to detect one or more of the one or more analysis trigger parameters within the message data.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 at least part of the message data associated with all of the message traffic to the virtual assets is monitored to detect one or more of the one or more analysis trigger parameters within the message data.

In one embodiment, at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 all of the message data associated with all of the message traffic to the virtual assets is monitored to detect one or more of the one or more analysis trigger parameters within the message data.

In one embodiment, the analysis of USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 is performed by the analysis trigger monitoring system in-line, or asynchronously off-line, on a per-message basis. Consequently, in some embodiments, an initial or first example of an intrusion message is passed through but would be used to stop other “like messages” where the criteria for “like” is an analysis trigger parameter that can be dynamically installed in the trigger monitoring system.

In addition, in one embodiment, analysis trigger parameters are applied heuristically at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 and new analysis trigger parameters that are discovered by the application of process 400 for intrusion detection in a cloud computing environment using network communications devices are added to create a self-learning intrusion detection system.

In one embodiment, once the analysis trigger data of GENERATE ANALYSIS TRIGGER DATA REPRESENTING THE ANALYSIS TRIGGER PARAMETERS OPERATION 411 and the analysis trigger monitoring system of PROVIDE A NETWORK COMMUNICATIONS DEVICE FOR RELAYING MESSAGE TRAFFIC SENT TO EACH OF THE VIRTUAL ASSETS OPERATION 405 are used to monitor at least part of the message data associated with at least some of the message traffic to the virtual assets relayed through the network communications device of PROVIDE A NETWORK COMMUNICATIONS DEVICE FOR RELAYING MESSAGE TRAFFIC SENT TO EACH OF THE VIRTUAL ASSETS OPERATION 405 at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415, process flow proceeds to CLASSIFY ANY DETECTED MESSAGE INCLUDING ONE OR MORE OF THE ONE OR MORE ANALYSIS TRIGGER PARAMETERS AS A SUSPECT MESSAGE OPERATION 417.

In one embodiment, at CLASSIFY ANY DETECTED MESSAGE INCLUDING ONE OR MORE OF THE ONE OR MORE ANALYSIS TRIGGER PARAMETERS AS A SUSPECT MESSAGE OPERATION 417, if one or more of the one or more analysis trigger parameters of DEFINE ONE OR MORE ANALYSIS TRIGGER PARAMETERS OPERATION 409 is detected within the message data associated with a given message, the classification data associated with that message is transformed into classification data indicating that the detected message including one or more of the one or more analysis trigger parameters is a suspect message.

In one embodiment, once the classification data associated with messages having one or more of the one or more analysis trigger parameters of DEFINE ONE OR MORE ANALYSIS TRIGGER PARAMETERS OPERATION 409 is transformed into classification data indicating that the detected message including one or more of the one or more analysis trigger parameters is a suspect message at CLASSIFY ANY DETECTED MESSAGE INCLUDING ONE OR MORE OF THE ONE OR MORE ANALYSIS TRIGGER PARAMETERS AS A SUSPECT MESSAGE OPERATION 417, process flow proceeds to FOR EACH SUSPECT MESSAGE GENERATE SUSPECT MESSAGE COPY DATA REPRESENTING A COPY OF AT LEAST A PORTION OF THE SUSPECT MESSAGE OPERATION 419.

In one embodiment, the detected suspect messages of CLASSIFY ANY DETECTED MESSAGE INCLUDING ONE OR MORE OF THE ONE OR MORE ANALYSIS TRIGGER PARAMETERS AS A SUSPECT MESSAGE OPERATION 417 are temporarily permitted to be transmitted to the virtual assets through the network communications channel with minimal delay.

In one embodiment, this transmission is permitted in order to avoid significantly disrupting or delaying the transmission of messages without further evidence that the suspect messages are indeed malicious. However, in one embodiment, at FOR EACH SUSPECT MESSAGE GENERATE SUSPECT MESSAGE COPY DATA REPRESENTING A COPY OF AT LEAST A PORTION OF THE SUSPECT MESSAGE OPERATION 419, for each detected suspect message of CLASSIFY ANY DETECTED MESSAGE INCLUDING ONE OR MORE OF THE ONE OR MORE ANALYSIS TRIGGER PARAMETERS AS A SUSPECT MESSAGE OPERATION 417, suspect message copy data is generated representing a copy of at least part of the message data making up the suspect message.

In one embodiment, for each detected suspect message of CLASSIFY ANY DETECTED MESSAGE INCLUDING ONE OR MORE OF THE ONE OR MORE ANALYSIS TRIGGER PARAMETERS AS A SUSPECT MESSAGE OPERATION 417, the at least part of the message data making up the suspect message is decrypted and decrypted suspect message copy data is generated representing a decrypted copy of at least part of the message data making up the suspect message at FOR EACH SUSPECT MESSAGE GENERATE SUSPECT MESSAGE COPY DATA REPRESENTING A COPY OF AT LEAST A PORTION OF THE SUSPECT MESSAGE OPERATION 419.

In one embodiment, once suspect message copy data is generated representing a copy of at least part of the message data making up the suspect message at FOR EACH SUSPECT MESSAGE GENERATE SUSPECT MESSAGE COPY DATA REPRESENTING A COPY OF AT LEAST A PORTION OF THE SUSPECT MESSAGE OPERATION 419 for each detected suspect message of CLASSIFY ANY DETECTED MESSAGE INCLUDING ONE OR MORE OF THE ONE OR MORE ANALYSIS TRIGGER PARAMETERS AS A SUSPECT MESSAGE OPERATION 417, process flow proceeds to TRANSFER THE SUSPECT MESSAGE COPY DATA TO ONE OR MORE ANALYSIS SYSTEMS FOR FURTHER ANALYSIS OPERATION 421.

In one embodiment, at TRANSFER THE SUSPECT MESSAGE COPY DATA TO ONE OR MORE ANALYSIS SYSTEMS FOR FURTHER ANALYSIS OPERATION 421, the suspect message copy data of FOR EACH SUSPECT MESSAGE GENERATE SUSPECT MESSAGE COPY DATA REPRESENTING A COPY OF AT LEAST A PORTION OF THE SUSPECT MESSAGE OPERATION 419 is transmitted to one or more analysis systems for further analysis in an “off-line” environment.

In one embodiment, at TRANSFER THE SUSPECT MESSAGE COPY DATA TO ONE OR MORE ANALYSIS SYSTEMS FOR FURTHER ANALYSIS OPERATION 421, the suspect message copy data of FOR EACH SUSPECT MESSAGE GENERATE SUSPECT MESSAGE COPY DATA REPRESENTING A COPY OF AT LEAST A PORTION OF THE SUSPECT MESSAGE OPERATION 419 is transmitted to the one or more analysis systems via a message analysis channel, also referred to herein as a second communications channel, that is distinct from the network communications channel, i.e., the first communications channel through which messages are transmitted from the virtual assets relayed by the network communications device of PROVIDE A CLOUD COMPUTING ENVIRONMENT INCLUDING ONE OR MORE VIRTUAL ASSETS OPERATION 403. In this way, the transmission of the suspect message copy data, and the subsequent message data analysis, does not affect the operation of the virtual asset, and/or the cloud computing environment, application, service, enterprise, and/or infrastructure associated with the virtual asset.

In one embodiment, multiple analysis systems are provided at TRANSFER THE SUSPECT MESSAGE COPY DATA TO ONE OR MORE ANALYSIS SYSTEMS FOR FURTHER ANALYSIS OPERATION 421 that are specifically implemented to analyze specific analysis trigger parameters of DEFINE ONE OR MORE ANALYSIS TRIGGER PARAMETERS OPERATION 409.

Consequently, in one embodiment, the particular analysis system to which a given example of suspect message data is transmitted at TRANSFER THE SUSPECT MESSAGE COPY DATA TO ONE OR MORE ANALYSIS SYSTEMS FOR FURTHER ANALYSIS OPERATION 421 is determined, at least in part, by the specific analysis trigger parameter detected in the suspect message at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 from which the suspect message copy data was derived at FOR EACH SUSPECT MESSAGE GENERATE SUSPECT MESSAGE COPY DATA REPRESENTING A COPY OF AT LEAST A PORTION OF THE SUSPECT MESSAGE OPERATION 419.

In one embodiment, if, as a result of the analysis of the suspect message copy data by one or more of the analysis systems at TRANSFER THE SUSPECT MESSAGE COPY DATA TO ONE OR MORE ANALYSIS SYSTEMS FOR FURTHER ANALYSIS OPERATION 421, it is determined that the suspect message is indeed associated with an intrusion attack, one or more systems, entities, and/or parties, are alerted to the situation so that appropriate protective action can be taken.

In one embodiment, if, as a result of the analysis of the suspect message copy data by one or more of the analysis systems at TRANSFER THE SUSPECT MESSAGE COPY DATA TO ONE OR MORE ANALYSIS SYSTEMS FOR FURTHER ANALYSIS OPERATION 421, it is determined that the suspect message is indeed associated with an intrusion attack, one or more protective actions are automatically taken to prevent further infection of the virtual assets, and/or other virtual assets, and/or the cloud computing environment, application, service, infrastructure, or computing environment, associated with the now identified infected virtual asset.

In various embodiments, the protective actions taken can include, but are not limited to, isolating the virtual asset such that the virtual asset can still continue to operate, but in total isolation of all other virtual assets; partially isolating the virtual asset such that the virtual asset is allowed to connect to some very specific virtual assets, but has most of its communication channels blocked; “killing” or terminating the virtual asset; repairing the virtual asset by re-loading the compromised sub-components of the virtual asset; and/or any other protective actions, or combination of protective actions, discussed herein, and/or as known in the art at the time of filing, and/or as developed, or become known, after the time of filing.

In addition, in one embodiment, analysis trigger parameters are applied heuristically at USE THE ANALYSIS TRIGGER MONITORING SYSTEM AND THE ANALYSIS TRIGGER DATA TO MONITOR AT LEAST A PORTION OF THE MESSAGE TRAFFIC SENT TO EACH OF THE ONE OR MORE VIRTUAL ASSETS TO DETECT ANY MESSAGE INCLUDING ONE OR MORE OF THE ONE OR MORE ANALYSIS TRIGGER PARAMETERS OPERATION 415 and if, as a result of the analysis of the suspect message copy data by one or more of the analysis systems at TRANSFER THE SUSPECT MESSAGE COPY DATA TO ONE OR MORE ANALYSIS SYSTEMS FOR FURTHER ANALYSIS OPERATION 421, it is determined that the suspect message is indeed associated with an intrusion attack, new analysis trigger parameters that are thereby discovered by the application of process 400 for intrusion detection in a cloud computing environment using network communications devices are added at to create a self-learning intrusion detection system.

In one embodiment, once the suspect message copy data of FOR EACH SUSPECT MESSAGE GENERATE SUSPECT MESSAGE COPY DATA REPRESENTING A COPY OF AT LEAST A PORTION OF THE SUSPECT MESSAGE OPERATION 419 is transmitted to one or more analysis systems for further analysis in an “off-line” environment at TRANSFER THE SUSPECT MESSAGE COPY DATA TO ONE OR MORE ANALYSIS SYSTEMS FOR FURTHER ANALYSIS OPERATION 421, process flow proceeds to EXIT OPERATION 430.

In one embodiment, at EXIT OPERATION 430 process 400 for intrusion detection in a cloud computing environment using network communications devices is exited to await new data.

Using process 400 for intrusion detection in a cloud computing environment using network communications devices discussed above, intrusion attacks can be detected using largely existing cloud computing environment infrastructure, such as network communication devices with added analysis trigger monitoring systems; without the need for devoting extensive and/or specialized resources. Consequently, using process 400 for intrusion detection in a cloud computing environment using network communications devices, intrusion events can be efficiently and effectively detected; thereby making distributed computing environments, such as cloud computing environments, more secure.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A system for extrusion detection in a cloud computing environment using network communications devices comprising:
at least one processor; and
at least one memory coupled to the at least one processor, the at least one memory having stored therein instructions which when executed by any set of the one or more processors, perform a process for extrusion detection in a cloud computing environment using network communications devices, the process for extrusion detection in a cloud computing environment using network communications devices including:
providing a cloud computing environment, the cloud computing environment including one or more virtual assets;
providing a network communications device, the network communications device receiving message traffic sent from any of the one or more virtual assets through a network communications channel;
providing an analysis trigger monitoring system implemented in the network communications device;
defining one or more analysis trigger parameters;
generating analysis trigger data representing the analysis trigger parameters;
providing the analysis trigger data to the analysis trigger monitoring system;
using the analysis trigger monitoring system and the analysis trigger data to monitor at least a portion of the message traffic sent from any of the one or more virtual assets to detect any message including one or more of the one or more analysis trigger parameters;
classifying any detected message including one or more of the one or more analysis trigger parameters as a suspect message;
for each suspect message, generating suspect message copy data representing a copy of at least a portion of the suspect message; and
transferring the suspect message copy data to one or more analysis systems for further analysis.

2. The system for extrusion detection in a cloud computing environment using network communications devices of claim 1 wherein at least one of the one or more virtual assets is a virtual asset selected from the group of the virtual assets consisting of:
a virtual machine;
a virtual server;
a virtual database or data store;
an instance in a cloud environment;
a cloud environment access system;
part of a mobile device;
part of a remote sensor;
part of a laptop;
part of a desktop;
part of a point-of-sale device;
part of an ATM; and
part of an electronic voting machine.

3. The system for extrusion detection in a cloud computing environment using network communications devices of claim 1 wherein the network communications device is selected from the group of network communications devices consisting of:
a switching system;
a network switch;
a router;
a border router;
any gateway system;
a firewall system;
a load balancing system; and
any hardware system through which message traffic to, and/or from, a cloud computing environment passes.

4. The system for extrusion detection in a cloud computing environment using network communications devices of claim 1 wherein the suspect message copy data is transferred to the analysis system for further analysis through a message analysis communications channel that is distinct from the network communications channel.

5. The system for extrusion detection in a cloud computing environment using network communications devices of claim 1 wherein the analysis trigger monitoring system monitors all of the message traffic sent from the one or more virtual assets received by the network communications device.

6. The system for extrusion detection in a cloud computing environment using network communications devices of claim 1 wherein the analysis trigger monitoring system monitors a sample portion of the message traffic sent from the one or more virtual assets received by the network communications device.

7. The system for extrusion detection in a cloud computing environment using network communications devices of claim 1 wherein at least one of the one or more analysis trigger parameters is selected from the group of analysis trigger parameters consisting of:
an IP address indicating a designated suspect destination;
an IP address indicating a designated suspect geographical region;
an IP address indicating a destination not included in an allowed destination list;
an IP address indicating a geographical region not included in an allowed geographical region list;
a message size that exceeds a threshold maximum message size;
a message size that does not meet a threshold minimum message size;
frequency analysis indicating messages arrive at frequency greater than a defined threshold frequency;
frequency analysis indicating messages arrive at frequency less than a defined threshold frequency;
the specific identity of a sender of a specific message;
the specific identity of a recipient of a specific message;
a hash value of the message data that is not included in a list of allowed hash values; and
an MD5 value of the message data that is not included in a list of allowed MD5 values.

8. The system for extrusion detection in a cloud computing environment using network communications devices of claim 1 wherein the suspect message copy data associated with a given suspect message is transferred to a specific analysis system of the one or more analysis systems for further analysis based, at least in part, on the specific analysis trigger parameter of the one or more analysis trigger parameters detected in the suspect message.

9. The system for extrusion detection in a cloud computing environment using network communications devices of claim 1 wherein if, as a result of the further analysis at the one or more analysis systems, the suspect message is determined to be an extrusion related message, one or more designated parties are automatically informed.

10. The system for extrusion detection in a cloud computing environment using network communications devices of claim 1 wherein if, as a result of the further analysis at the one or more analysis systems, the suspect message is determined to be an extrusion related message, one or more protective actions are automatically implemented.

11. A system for intrusion detection in a cloud computing environment using network communications devices comprising:
at least one processor; and
at least one memory coupled to the at least one processor, the at least one memory having stored therein instructions which when executed by any set of the one or more processors, perform a process for intrusion detection in a cloud computing environment using network communications devices, the process for intrusion detection in a cloud computing environment using network communications devices including:
providing a cloud computing environment, the cloud computing environment including one or more virtual assets;
providing a network communications device, the network communications device receiving message traffic sent to any of the one or more virtual assets;
providing an analysis trigger monitoring system implemented in the network communications device;
defining one or more analysis trigger parameters;
generating analysis trigger data representing the analysis trigger parameters;
providing the analysis trigger data to the analysis trigger monitoring system;
using the analysis trigger monitoring system and the analysis trigger data to monitor at least a portion of the message traffic sent to any of the one or more virtual assets to detect any message including one or more of the one or more analysis trigger parameters;
classifying any detected message including one or more of the one or more analysis trigger parameters as a suspect message;
for each suspect message, generating suspect message copy data representing a copy of at least a portion of the suspect message; and
transferring the suspect message copy data to one or more analysis systems for further analysis.

12. The system for intrusion detection in a cloud computing environment using network communications devices of claim 11 wherein at least one of the one or more virtual assets is a virtual asset selected from the group of the virtual assets consisting of:
a virtual machine;
a virtual server;
a virtual database or data store;
an instance in a cloud environment;
a cloud environment access system;
part of a mobile device;
part of a remote sensor;
part of a laptop;
part of a desktop;
part of a point-of-sale device;
part of an ATM; and
part of an electronic voting machine.

13. The system for intrusion detection in a cloud computing environment using network communications devices of claim 11 wherein the network communications device is selected from the group of network communications devices consisting of:
a switching system;
a network switch;
a router;
a border router;
any gateway system;
a firewall system;
a load balancing system; and
any hardware system through which message traffic to, and/or from, a cloud computing environment passes.

14. The system for intrusion detection in a cloud computing environment using network communications devices of claim 11 wherein the suspect message copy data is transferred to the analysis system for further analysis through a message analysis communications channel that is distinct from the network communications channel.

15. The system for intrusion detection in a cloud computing environment using network communications devices of claim 11 wherein the analysis trigger monitoring system monitors all of the message traffic sent to the one or more virtual assets received by the network communications device.

16. The system for intrusion detection in a cloud computing environment using network communications devices of claim 11 wherein the analysis trigger monitoring system monitors a sample portion of the message traffic sent to the one or more virtual assets received by the network communications device.

17. The system for intrusion detection in a cloud computing environment using network communications devices of claim 11 wherein at least one of the one or more analysis trigger parameters is selected from the group of analysis trigger parameters consisting of:
an IP address indicating a designated suspect origin;
an IP address indicating a designated suspect geographical region;
an IP address indicating an origin not included in an allowed origin or destination list;
an IP address indicating a geographical region not included in an allowed geographical region list;
a message size that exceeds a threshold maximum message size;
a message size that does not meet a threshold minimum message size;
frequency analysis indicating messages arrive at frequency greater than a defined threshold frequency;
frequency analysis indicating messages arrive at frequency less than a defined threshold frequency;
the specific identity of a sender of a specific message;
the specific identity of a recipient of a specific message;
a hash value of the message data that is not included in a list of allowed hash values; and
an MD5 value of the message data that is not included in a list of allowed MD5 values.

18. The system for intrusion detection in a cloud computing environment using network communications devices of claim 11 wherein the suspect message copy data associated with a given suspect message is transferred to a specific analysis system of the one or more analysis systems for further analysis based, at least in part, on the specific analysis trigger parameter of the one or more analysis trigger parameters detected in the suspect message.

19. The system for intrusion detection in a cloud computing environment using network communications devices of claim 11 wherein if, as a result of the further analysis at the one or more analysis systems, the suspect message is determined to be an intrusion related message, one or more designated parties are automatically informed.

20. The system for intrusion detection in a cloud computing environment using network communications devices of claim 11 wherein if, as a result of the further analysis at the one or more analysis systems, the suspect message is determined to be an intrusion related message, one or more protective actions are automatically implemented.

21. A system for extrusion detection in a cloud computing environment using network communications devices comprising:
a cloud computing environment, the cloud computing environment including one or more virtual assets;
a network communications device, the network communications device receiving message traffic sent from any of the one or more virtual assets;
a network communications channel through which all the message traffic sent from the one or more virtual assets is relayed through the network communications device;
an analysis trigger monitor, the analysis trigger monitor being associated with the network communications device;
one or more analysis systems for performing analysis of message copy data representing a copy of at least a portion of a suspect message;
at least one message analysis communications channel that is distinct from the network communications channel for transferring the suspect message copy data to the one or more analysis systems for further analysis;
at least one processor; and
at least one memory coupled to the at least one processor, the at least one memory having stored therein instructions which when executed by any set of the one or more processors, perform a process for extrusion detection in a cloud computing environment using network communications devices, the process for extrusion detection in a cloud computing environment using network communications devices including:
defining one or more analysis trigger parameters;
generating analysis trigger data representing the analysis trigger parameters;
providing the analysis trigger data to the analysis trigger monitor;
using the analysis trigger monitor and the analysis trigger data to monitor at least a portion of the message traffic sent from any of the one or more virtual assets to detect any message including one or more of the one or more analysis trigger parameters;
classifying any detected message including one or more of the one or more analysis trigger parameters as a suspect message;
for each suspect message, generating suspect message copy data representing a copy of at least a portion of the suspect message; and
using the message analysis communications channel to transfer the suspect message copy data to one or more of the one or more analysis systems for further analysis.

22. The system for extrusion detection in a cloud computing environment using network communications devices of claim 21 wherein at least one of the virtual assets is a virtual asset selected from the group of the virtual assets consisting of:
a virtual machine;
a virtual server;
a virtual database or data store;
an instance in a cloud environment;
a cloud environment access system;
part of a mobile device;
part of a remote sensor;
part of a laptop;
part of a desktop;
part of a point-of-sale device;
part of an ATM; and
part of an electronic voting machine.

23. The system for extrusion detection in a cloud computing environment using network communications devices of claim 21 wherein the network communications device is selected from the group of network communications devices consisting of:
a switching system;
a network switch;
a router;
a border router;
any gateway system;
a firewall system;
a load balancing system; and
any hardware system through which message traffic to, and/or from, a cloud computing environment passes.

24. The system for extrusion detection in a cloud computing environment using network communications devices of claim 21 wherein the analysis trigger monitor monitors all of the message traffic sent from the one or more virtual assets.

25. The system for extrusion detection in a cloud computing environment using network communications devices of claim 21 wherein the analysis trigger monitor monitors a sample portion of the message traffic sent from the one or more virtual assets.

26. The system for extrusion detection in a cloud computing environment using network communications devices of claim 21 wherein at least one of the one or more analysis trigger parameters is selected from the group of analysis trigger parameters consisting of:
an IP address indicating a designated suspect destination;
an IP address indicating a designated suspect geographical region;
an IP address indicating a destination not included in an allowed destination list;
an IP address indicating a geographical region not included in an allowed geographical region list;
a message size that exceeds a threshold maximum message size;
a message size that does not meet a threshold minimum message size;
frequency analysis indicating messages arrive at frequency greater than a defined threshold frequency;
frequency analysis indicating messages arrive at frequency less than a defined threshold frequency;
the specific identity of a sender of a specific message;
the specific identity of a recipient of a specific message;
a hash value of the message data that is not included in a list of allowed hash values; and
an MD5 value of the message data that is not included in a list of allowed MD5 values.

27. The system for extrusion detection in a cloud computing environment using network communications devices of claim 21 wherein the suspect message copy data associated with a given suspect message is transferred to a specific analysis system of the one or more analysis systems for further analysis based, at least in part, on the specific analysis trigger parameter of the one or more analysis trigger parameters detected in the suspect message.

28. The system for extrusion detection in a cloud computing environment using network communications devices of claim 21 wherein if, as a result of the further analysis at the one or more analysis systems, the suspect message is determined to be an extrusion related message, one or more designated parties are automatically informed.

29. The system for extrusion detection in a cloud computing environment using network communications devices of claim 21 wherein if, as a result of the further analysis at the one or more analysis systems, the suspect message is determined to be an extrusion related message, one or more protective actions are automatically implemented.

30. A system for intrusion detection in a cloud computing environment using network communications devices comprising:
a cloud computing environment, the cloud computing environment including one or more virtual assets;
a network communications device, the network communications device receiving message traffic sent to any of the one or more virtual assets;
a network communications channel through which all the message traffic sent to any of the one or more virtual assets is relayed through the network communications device;
an analysis trigger monitoring module, the analysis trigger monitoring module being associated with the network communications device;
one or more analysis systems for performing analysis of message copy data representing a copy of at least a portion of a suspect message;
at least one message analysis communications channel that is distinct from the network communications channel for transferring the suspect message copy data to the one or more analysis systems for further analysis;
at least one processor; and
at least one memory coupled to the at least one processor, the at least one memory having stored therein instructions which when executed by any set of the one or more processors, perform a process for intrusion detection in a cloud computing environment using network communications devices, the process for intrusion detection in a cloud computing environment using network communications devices including:
defining one or more analysis trigger parameters;
generating analysis trigger data representing the analysis trigger parameters;
providing the analysis trigger data to the analysis trigger monitoring module;
using the analysis trigger monitoring module and the analysis trigger data to monitor at least a portion of the message traffic sent to any of the one or more virtual assets to detect any message including one or more of the one or more analysis trigger parameters;
classifying any detected message including one or more of the one or more analysis trigger parameters as a suspect message;
for each suspect message, generating suspect message copy data representing a copy of at least a portion of the suspect message; and
using the message analysis communications channel to transfer the suspect message copy data to one or more of the one or more analysis systems for further analysis.

31. The system for intrusion detection in a cloud computing environment using network communications devices of claim 30 wherein at least one of the virtual assets is a virtual asset selected from the group of the virtual assets consisting of:
a virtual machine;
a virtual server;
a virtual database or data store;
an instance in a cloud environment;
a cloud environment access system;
part of a mobile device;
part of a remote sensor;
part of a laptop;
part of a desktop;
part of a point-of-sale device;
part of an ATM; and
part of an electronic voting machine.

32. The system for intrusion detection in a cloud computing environment using network communications devices of claim 30 wherein the network communications device is selected from the group of network communications devices consisting of:
a switching system;
a network switch;
a router;
a border router;
any gateway system;
a firewall system;
a load balancing system; and
any hardware system through which message traffic to, and/or from, a cloud computing environment passes.

33. The system for intrusion detection in a cloud computing environment using network communications devices of claim 30 wherein the analysis trigger monitor monitors all of the message traffic sent to the one or more virtual assets.

34. The system for intrusion detection in a cloud computing environment using network communications devices of claim 30 wherein the analysis trigger monitor monitors a sample portion of the message traffic sent to the one or more virtual assets.

35. The system for intrusion detection in a cloud computing environment using network communications devices of claim 30 wherein at least one of the one or more analysis trigger parameters is selected from the group of analysis trigger parameters consisting of:
an IP address indicating a designated suspect origin;
an IP address indicating a designated suspect geographical region;
an IP address indicating a destination not included in an allowed origin list;
an IP address indicating a geographical region not included in an allowed geographical region list;
a message size that exceeds a threshold maximum message size;
a message size that does not meet a threshold minimum message size;
frequency analysis indicating messages arrive at frequency greater than a defined threshold frequency;
frequency analysis indicating messages arrive at frequency less than a defined threshold frequency;
the specific identity of a sender of a specific message;
the specific identity of a recipient of a specific message;
a hash value of the message data that is not included in a list of allowed hash values; and
an MD5 value of the message data that is not included in a list of allowed MD5 values.

36. The system for intrusion detection in a cloud computing environment using network communications devices of claim 30 wherein the suspect message copy data associated with a given suspect message is transferred to a specific analysis system of the one or more analysis systems for further analysis based, at least in part, on the specific analysis trigger parameter of the one or more analysis trigger parameters detected in the suspect message.

37. The system for intrusion detection in a cloud computing environment using network communications devices of claim 30 wherein if, as a result of the further analysis at the one or more analysis systems, the suspect message is determined to be an intrusion related message, one or more designated parties are automatically informed.

38. The system for intrusion detection in a cloud computing environment using network communications devices of claim 30 wherein if, as a result of the further analysis at the one or more analysis systems, the suspect message is determined to be an intrusion related message, one or more protective actions are automatically implemented.
